(19) United States
(12) Patent Application Publication
(10) Pub. No.: US 2026/0289106 A1
(43) Pub. Date: Sep. 24, 2026

(54) SYSTEM

(71) Applicant: SoftBank Group Corp., Tokyo (JP)

(72) Inventor: Takayuki OZAKI, Tokyo (JP)

(73) Assignee: SoftBank Group Corp., Tokyo (JP)

(21) Appl. No.: 19/564,168

(22) Filed: Mar. 12, 2026

(30) Foreign Application Priority Data
Mar. 19, 2025 (JP) 2025-044959

(51) Int. Cl. G06F 40/20; G06N 3/0475; G06V 40/16

(52) U.S. Cl. CPC G06F 40/20; G06N 3/0475; G06V 40/165

(57) ABSTRACT

A system includes a processor that is configured to: receive input from a learner and analyze the input, retrieve information regarding a specific subject or course from a database based on the analysis of the input, and generate a prompt sentence for instructing a generative artificial intelligence model to generate an answer, and input the prompt sentence to the generative artificial intelligence model.

### CROSS-REFERENCE TO RELATED APPLICATION

This application is based on and claims priority under 35 USC 119 from Japanese Patent Application No. 2025-044959 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional educational support systems and chatbots generally provide uniform responses that do not sufficiently reflect individual learners'needs, such as the specific subject matter being requested, the learner's understanding level, or the learner's emotional state. In many cases, the system merely retrieves predefined content or simple FAQ entries, which leads to limited flexibility and an inability to cope with diverse and complex questions. Furthermore, even when a generative artificial intelligence model is employed, the system often lacks a mechanism for constructing appropriate prompts based on database information and learner context, resulting in answers that may be irrelevant, superficial, or pedagogically inappropriate. Still further, existing systems seldom evaluate a learner's understanding level from past interaction data, and seldom analyze the learner's emotional state from voice or text, so that the responses are not adaptively adjusted to the learner's cognitive and emotional conditions. As a result, it is difficult to provide highly personalized, context-aware, and emotionally supportive guidance suitable for educational and training environments.

### SUMMARY

In order to solve the above-described problems, a system according to at least one embodiment of the present invention comprises a processor, wherein the processor is configured to receive input from a learner and analyze the input, retrieve information regarding a specific subject or course from a database based on the analysis of the input, and generate a prompt sentence for instructing a generative artificial intelligence model to generate an answer, and input the prompt sentence to the generative artificial intelligence model. The processor is further configured, in some embodiments, to analyze past interaction data of the learner and evaluate an understanding level of the learner, and to reflect the evaluated understanding level in the analysis of the input, in the retrieval of information from the database, and in the generation of the prompt sentence, thereby enabling the generative artificial intelligence model to produce an answer adapted to the learner's level. In addition, the processor is further configured, in some embodiments, to analyze voice data or text data of the learner, determine an emotional state of the learner, and adjust a response according to the emotional state, for example by modifying the content, tone, or detail of the answer, thereby providing context-aware and emotionally appropriate feedback. By combining database-based subject retrieval, prompt generation for a generative artificial intelligence model, understanding-level evaluation, and emotion-aware response adjustment, the system enables dynamic, personalized, and pedagogically suitable responses for learners.

The term “learner” refers to a human user who uses the system for the purpose of study, training, education, or acquisition of knowledge or skills, and who inputs queries or other data to the system.

The term “input” refers to information provided by the learner to the system, including but not limited to natural-language text, voice data, or other interaction data that expresses a question, request, or intention of the learner.

The term “analyze the input” refers to processing the input in order to extract meaningful information, such as topics, intents, keywords, linguistic structures, or other features that are useful for retrieving information or constructing a prompt.

The term “specific subject or course” refers to a defined field or domain of knowledge or instruction, such as mathematics, history, science, language learning, or a particular educational curriculum or training program.

The term “database” refers to any structured or semi-structured storage of data that can be accessed by the processor, including but not limited to relational databases, document stores, knowledge bases, or other data repositories.

The term “retrieve information” refers to performing a search or lookup in the database based on the analysis of the input, and obtaining one or more pieces of data, records, documents, or knowledge items relevant to the specific subject or course.

The term “generative artificial intelligence model” refers to a computational model, such as a large language model or other generative model, that is capable of producing natural-language text or other content as an output in response to an input prompt.

The term “prompt sentence” refers to a textual instruction or sequence of tokens generated by the processor, which is provided as input to the generative artificial intelligence model and which specifies or guides the content, style, or constraints of the answer to be generated.

The term “past interaction data” refers to information representing previous exchanges between the learner and the system, including prior questions, answers, time stamps, performance records, or other logs of the learner's usage history.

The term “evaluate an understanding level” refers to estimating, classifying, or quantifying the learner's degree of knowledge, proficiency, or mastery with respect to one or more subjects or courses, based on analysis of the past interaction data.

The term “voice data” refers to audio signals or processed audio features that capture spoken utterances of the learner, including any representation suitable for analysis by the processor.

The term “text data” refers to character-based or token-based representations of language produced by the learner, such as chat messages, typed questions, written answers, or transcripts of speech.

The term “emotional state” refers to an inferred affective condition of the learner, such as frustration, confusion, confidence, satisfaction, or other emotional categories, estimated by analyzing the learner's voice data or text data.

The term “adjust a response” refers to modifying at least one aspect of a system output, including but not limited to content, detail, tone, complexity, length, or presentation style, based on the evaluated understanding level and/or the determined emotional state of the learner.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

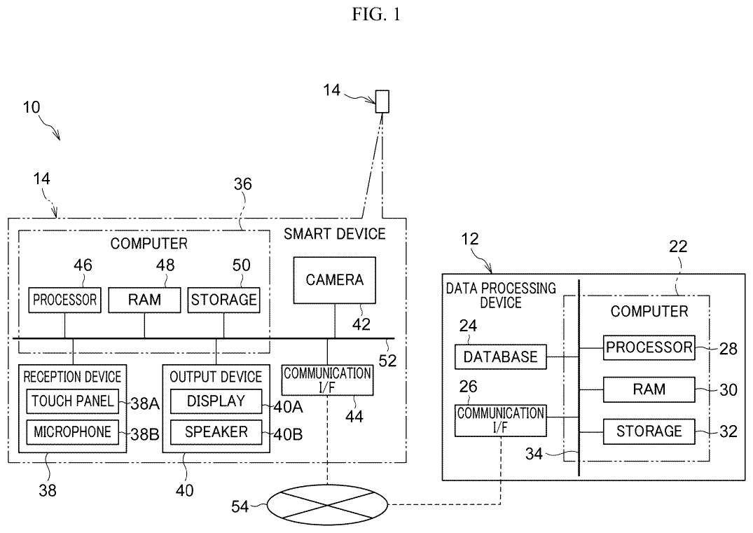

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

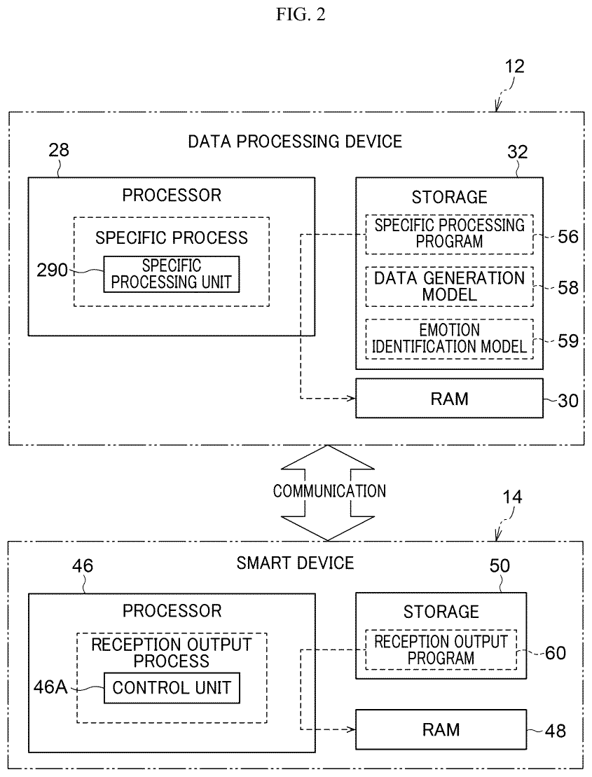

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning support systems that utilize generative AI models typically treat a learner's inquiry as a simple text prompt and directly forward the raw text to a generative AI model. Such systems often lack structured analysis of the inquiry, fail to incorporate individualized learner attributes, and do not systematically use accumulated interaction history. As a result, these systems tend to generate responses that are either too difficult or too simple, are inconsistent in style, or are not sufficiently aligned with the learner's current understanding and emotional state.

In addition, many existing systems rely on static prompts or manually crafted templates, which do not dynamically adapt to changes in the learner's comprehension level or progress over time. This leads to inefficient use of computational resources, because generative AI models are invoked with suboptimal prompt sentences that do not fully exploit the available contextual data or prior interactions. Furthermore, insufficient preprocessing and postprocessing of text data can degrade the effectiveness of the underlying natural language processing pipeline, resulting in ambiguous or noisy inputs and outputs that reduce the accuracy, safety, and utility of the generated responses.

From a computer technology perspective, there is a need for an improved processing architecture that: (i) systematically analyzes learner inquiries using natural language processing, (ii) integrates learner attribute information and interaction history into a dynamically constructed prompt sentence, (iii) controls the generative AI model through such structured prompt sentences, and (iv) performs automated postprocessing, including inappropriate-content detection and formatting, to produce responses optimized for the learner's learning level and emotional state. There is also a need to compute and maintain machine-usable comprehension and achievement indices, and to use these indices to automatically adjust, at the prompt-construction stage, the level of detail, technical vocabulary, and output volume of responses, thereby improving the technical performance, consistency, and adaptability of the overall computer-implemented learning system.

The specific processing by the specific processing unit 290 of the data processing device 12 in Example 1 is realized by the following means.

The present invention provides a server comprising a processor and a memory storing instructions that, when executed by the processor, cause the server to receive, via a terminal, inquiry input from a learner as character information; to perform natural language processing on the character information to execute word segmentation, syntactic analysis, semantic analysis, and intent estimation, and to extract subject information and learning-purpose information related to the inquiry input; to acquire, from a storage device, learner attribute information and past interaction history information associated with the learner, and to determine a learning level, a preferred explanation style, and an area of interest of the learner; to acquire, from a knowledge information storage area, subject-related information based on the subject information and the learning level of the learner, and to construct a prompt sentence for input to a generative AI model, the prompt sentence including the subject-related information, the learning-purpose information, and the learning level of the learner; to generate generation request data including the prompt sentence and generation condition information, to transmit the generation request data to the generative AI model, and to acquire a response character string generated by the generative AI model; to perform inappropriate-content detection and expression-format conversion on the response character string, and to format the response character string so as to conform to the learning level and an emotional state of the learner; to transmit the formatted response character string to the terminal and cause the formatted response character string to be presented in a dialog-type display region; and to store the inquiry input, the prompt sentence, and the response character string as interaction history, and to use the interaction history for configuration of a subsequent prompt sentence and individualized optimization of subsequent response content. This enables improvement of computer-based learning support by technically enhancing the way textual inquiries are analyzed, contextual learner data are integrated into dynamically constructed prompt sentences, and generative AI model outputs are postprocessed, thereby providing more accurate, context-aware, and safely formatted responses while efficiently utilizing computing resources and enabling adaptive, history-based control of the generative AI model.

The term “processor” refers to a hardware or virtual computing element, such as a central processing unit or a processing core, that executes computer-readable instructions to perform arithmetic, logic, control, and input/output operations.

The term “terminal” refers to an information processing device, such as a personal computer, a tablet device, or a mobile communication device, that provides a user interface enabling a learner to input data to, and receive data from, a server.

The term “learner” refers to a user who utilizes the system for acquiring knowledge or skills in an educational or training context.

The term “inquiry input” refers to information, such as a question or request for explanation, that is entered by a learner through a terminal and transmitted to the server for processing.

The term “character information” refers to data representing text, including letters, numbers, symbols, and punctuation, encoded in a machine-readable format.

The term “natural language processing” refers to a set of computational techniques for analyzing and processing human language text, including but not limited to tokenization, syntactic analysis, semantic analysis, and intent estimation.

The term “word segmentation” refers to a process of dividing character information into discrete linguistic units such as words or tokens.

The term “syntactic analysis” refers to a process of analyzing grammatical structure of a sentence to identify relationships among words or tokens.

The term “semantic analysis” refers to a process of determining meaning or contextual interpretation of words, phrases, and sentences contained in character information.

The term “intent estimation” refers to a process of inferring a purpose or objective underlying an inquiry input, such as a request for explanation, definition, comparison, or example.

The term “subject information” refers to data identifying a topic, field, or domain, such as a specific academic subject or concept, that is related to an inquiry input.

The term “learning-purpose information” refers to data indicating a goal or desired outcome of a learner, such as understanding a concept, practicing problem-solving, or preparing for an assessment.

The term “learner attribute information” refers to data associated with a learner, including but not limited to learning level, preferred explanation style, proficiency, and areas of interest.

The term “interaction history information” refers to stored records of past exchanges between a learner and the system, including inquiry inputs, prompt sentences, response character strings, timestamps, and related metadata.

The term “learning level” refers to an indicator of a learner's current degree of knowledge or proficiency in a subject, such as an educational grade level or a difficulty level.

The term “preferred explanation style” refers to a manner of presenting information that a learner favors, such as step-by-step explanation, concise summary, or example-based explanation.

The term “area of interest” refers to a subject field, topic, or theme that is identified as particularly relevant or appealing to a learner based on learner attribute information or interaction history information.

The term “storage device” refers to a hardware or virtual component, such as a magnetic disk, a solid-state drive, or a network storage system, configured to store and retrieve data under control of the processor.

The term “knowledge information storage area” refers to a logical or physical data storage region that holds subject-related information such as educational content, reference data, or structured knowledge used to generate responses.

The term “subject-related information” refers to data items, including explanatory text or structured facts, that are associated with a particular subject or topic relevant to a learner's inquiry.

The term “prompt sentence” refers to text data constructed by the processor and provided as input to a generative AI model, the text data specifying instructions, context, and content necessary for the generative AI model to generate an appropriate response.

The term “generative AI model” refers to a machine learning model, typically a neural network, that generates output data such as natural language text in response to input data including a prompt sentence.

The term “generation condition information” refers to parameters supplied to a generative AI model, such as maximum output length, randomness control values, or format constraints, that influence characteristics of generated output.

The term “generation request data” refers to a data structure transmitted to a generative AI model, including at least a prompt sentence and generation condition information, and instructing the generative AI model to generate a response.

The term “response character string” refers to text output generated by a generative AI model in response to generation request data, represented as character information.

The term “inappropriate-content detection” refers to a process of analyzing a response character string to determine whether the response character string contains content that is harmful, offensive, unsafe, or otherwise unsuitable according to predetermined criteria.

The term “expression-format conversion” refers to a process of transforming a response character string into a desired representation, including adjustment of style, structure, or markup to improve readability or suitability for a learner.

The term “emotional state” refers to a psychological condition of a learner, such as being confused, frustrated, motivated, or confident, which may be inferred from interaction data.

The term “dialog-type display region” refers to a user interface area on a terminal that presents exchanges between a learner and the system in a conversational format, typically as a sequence of messages.

The term “interaction history” refers to a collection of records of past interactions between a learner and the system, including inquiry inputs, prompt sentences, response character strings, and associated contextual information, stored for later use.

The term “comprehension index” refers to a numerical or categorical indicator representing an estimated level of understanding of a learner with respect to particular content or subject matter, derived from interaction history.

The term “achievement index” refers to a numerical or categorical indicator representing an estimated level of progress or attainment of learning objectives by a learner, derived from interaction history.

The term “audio information” refers to data representing sound signals acquired from a learner, including spoken utterances, captured by an audio input device and processed by the system.

The term “emotion estimation processing” refers to a process of analyzing audio information and character information to infer an emotional state of a learner using rules, statistical methods, or machine learning techniques.

The term “encouragement expression” refers to a phrase or wording inserted into a prompt sentence or response that is intended to motivate, reassure, or positively support a learner.

The term “difficulty-change instruction” refers to control information included in a prompt sentence that directs the generative AI model to increase or decrease the complexity or depth of a generated response.

The term “explanation-style-change instruction” refers to control information included in a prompt sentence that directs the generative AI model to modify a manner of explanation, such as switching from a detailed explanation to a simplified summary or to an example-based explanation.

In one embodiment, a server, a terminal, and a user cooperate to implement a computer-implemented learning support system that utilizes a generative AI model controlled by a dynamically constructed prompt sentence. The server includes a processor, a memory, one or more storage devices, and one or more communication interfaces. The terminal includes a display unit, an input unit, a communication module, and optionally an audio input unit and an audio output unit. The user operates the terminal to access the system.

The server uses generic hardware such as a multi-core central processing unit and, in some embodiments, one or more graphics processing units. For example, the server uses a processor compatible with an x86 or ARM instruction set, a main memory, and a non-volatile storage device such as a solid-state drive. The server executes an operating system such as a generic server operating system and runs application software implemented by a web application framework such as a server-side framework for network communication and HTTP request handling. The server also uses a natural language processing library such as a tokenization and parsing library (for example, a model comparable to spaCy or a transformer-based encoder), and a generative AI model library such as a transformer-based text generation framework comparable to those provided in a general-purpose machine learning library.

The terminal uses generic computing hardware such as a mobile communication device, a tablet device, or a personal computer. The terminal executes a client application, such as a web browser running a script-based front-end framework or a native learning application. The terminal presents a chat-type display region on the display unit and acquires character information or audio information from the user through a keyboard, touch screen, or microphone.

The server stores multiple software modules in the memory. The modules include at least (i) an input acquisition module, (ii) a natural language processing module, (iii) a learner profile management module, (iv) a prompt construction module, (v) a generative AI interface module, (vi) a moderation and formatting module, (vii) an interaction history management module, and (viii) an emotion estimation module. Each module is implemented as a set of instructions that the processor executes to perform data processing on specific data structures stored in the memory and in the storage devices.

The server acquires inquiry input as character information from the terminal. The natural language processing module uses specific data structures, such as token sequences and parse trees, to represent the inquiry. For example, the server stores the inquiry string in a buffer, then represents it as a list of token objects, each token object including attributes such as a token identifier, a part-of-speech tag, a lemma, and dependency information. The server applies a syntactic parsing algorithm based on a dependency parser or a constituency parser to build a parse tree. The server also computes a semantic embedding of the inquiry using a transformer encoder that maps tokens into a high-dimensional vector space. The server stores the embedding as a numeric array in the memory.

The server uses an intent classification submodule that applies a trained classifier to the semantic embedding and token features. The classifier is, in one embodiment, a feed-forward neural network with multiple fully connected layers and a softmax output layer, trained to output an intent label such as “request for explanation,” “request for example,” or “request for quiz.” The server uses this intent label and the parse tree to derive subject information and learning-purpose information. For example, when the inquiry is “Please explain the process of photosynthesis,” the server identifies “photosynthesis” as a subject keyword and “explain the process” as learning-purpose information indicating a conceptual explanation with process steps.

The learner profile management module retrieves learner attribute information from a database stored on the storage device. The server maintains a relational table or a document collection that stores, for each learner, attributes such as a learning level, a preferred explanation style, and an area of interest. The server calculates derived attributes such as a numerical learning level score and a vector of interest weights per subject category. The server also accesses interaction history, which is stored in a structured format containing, for each previous interaction, fields such as timestamp, inquiry text, prompt sentence, response character string, comprehension index, and achievement index. This structured storage enables efficient retrieval and aggregation by indexes on learner identifiers and subject categories.

The server uses these stored structures to compute or update comprehension indices and achievement indices. In one embodiment, the server uses a regression or classification model that receives features extracted from the interaction history, such as the number of correct answers to generated quizzes, the number of requests for simplification, and the time taken to proceed to more advanced topics. The server represents these features as numeric vectors and uses a trained model, such as a gradient-boosted decision tree or a small neural network, to output scalar scores representing comprehension and achievement. This technical approach goes beyond simple logging and directly shapes the internal computational state used for subsequent prompt construction.

The prompt construction module generates a prompt sentence for the generative AI model using a structured algorithm. The server creates a prompt sentence that concatenates multiple segments with specific roles: a system-level instruction segment, a learner-context segment, and a user-inquiry segment. For example, the server constructs a prompt sentence as follows:

“You are a friendly biology tutor for high school students.

Explain scientific concepts clearly and accurately using simple English.

A student is asking about the topic ‘photosynthesis’.

Please explain the process of photosynthesis step by step.

Describe the roles of light, chlorophyll, carbon dioxide, water, oxygen, and glucose.

Use short paragraphs and avoid overly technical jargon.

The student's exact question is: ‘Please explain the process of photosynthesis.’”

In another embodiment, the server constructs a simplified prompt sentence for a younger learner, such as:

“You are a science teacher for 10-year-old students.

Explain photosynthesis using very simple words and short sentences.

Avoid difficult scientific terms unless you define them.

The student's question is: ‘Please explain the process of photosynthesis.’”

The prompt construction module selects the wording, level of detail, and style indicators according to the learner's learning level, preferred explanation style, comprehension index, and achievement index. The server combines these parameters into a single character string that encodes non-trivial control information for the generative AI model. From a technical standpoint, the prompt sentence acts as a dynamic control program for the generative AI model, rather than a static human-authored template. This approach improves the internal efficiency and output relevance of the generative AI model, resulting in fewer unnecessary tokens and reduced communication bandwidth between the server and the model host.

The generative AI interface module sends generation request data to the generative AI model. In one embodiment, the generative AI model is a transformer-based neural network deployed on a separate computing node equipped with one or more graphics processing units. The generative AI model includes multiple self-attention layers, feed-forward layers, and normalization layers. The server encodes the prompt sentence into token identifiers using a tokenizer that applies subword segmentation such as byte pair encoding. The server then transmits the token sequence and generation condition information, including a maximum number of output tokens, a temperature parameter, and a top-p parameter, to the generative AI model via a communication interface using a network protocol such as HTTP over a secure channel.

The generative AI model generates a response character string by iteratively computing probability distributions over the token vocabulary for each output position. Internally, the model uses a training procedure based on stochastic gradient descent with a cross-entropy loss function during pre-training and optional fine-tuning. During operation, the model employs attention mechanisms to compute weighted sums of token embeddings, thereby capturing context over the entire prompt sentence. The use of learned parameters in a multi-layer transformer architecture enables the model to combine subject-related information, learner-level instructions, and explicit style constraints present in the prompt sentence in a manner that is not feasible with conventional rule-based systems.

The moderation and formatting module on the server receives the generated response character string and applies further processing. The server performs inappropriate-content detection by using a classification model that predicts whether the response includes harmful or unsuitable expressions. The server represents the response as a sequence of tokens and as an embedding vector, then applies a binary or multi-class classifier, such as a neural network or a support vector machine, trained on labeled examples of appropriate and inappropriate content. If the classifier indicates that content is inappropriate or ambiguous, the server either requests regeneration with modified generation condition information or removes or replaces specific phrases according to a rule set.

The server then executes expression-format conversion. For example, the server inserts paragraph breaks, converts markdown-like markers to HTML tags if the terminal requires structured layout, and simplifies sentence structures for learners with lower learning levels. The processing uses deterministic text transformation rules stored in a rule table, as well as heuristics that adjust sentence length and complexity based on the learner's comprehension index. This combination of model-based and rule-based processing yields a technically improved pipeline in which the generative AI model focuses on semantic content generation and the server-side postprocessing enforces style, safety, and readability constraints.

The interaction history management module records each interaction in a structured format. The server stores the inquiry input, the prompt sentence, the response character string, the learner identifiers, and computed indices in a database. The server organizes this data using indexes on learner identifiers, timestamps, and subject categories, thereby enabling efficient querying and aggregation. Because the prompt sentences themselves are stored, the server can later analyze which prompt configurations lead to higher comprehension and achievement indices, and can update internal policy parameters accordingly. This feedback loop improves the efficiency of prompt construction and response generation over time, representing a technical improvement in system-level behavior rather than a mere automation of human teaching strategies.

The emotion estimation module analyzes character information and, when available, audio information from the user. The server converts audio signals into spectral features using known signal processing methods such as short-time Fourier transforms and extracts prosodic features including pitch, energy, and speech rate. The server also extracts textual indicators from character information, such as the presence of exclamations or repeated question marks. The server combines these features into a feature vector and feeds the vector into a trained classification model, such as a recurrent neural network or a transformer encoder, that outputs an estimated emotional state. The server then alters the prompt sentence by inserting an encouragement expression, a difficulty-change instruction, or an explanation-style-change instruction according to the estimated emotional state. For example, the server may add the following lines to the prompt sentence:

“The student seems frustrated.

Please respond with extra encouragement and a simpler explanation first.

Use supportive language and avoid complex terminology.”

This integration of emotion estimation with prompt construction enables the server to control the generative AI model in a way that is technically distinct from traditional keyword-based or static prompt approaches.

From a technical perspective, the described configuration improves computer technology in several ways. First, the server reduces unnecessary computation and communication by tailoring the prompt sentence so that the generative AI model receives only necessary and contextually relevant instructions. Because the generative AI model can produce a suitable answer with fewer tokens and less trial-and-error, the total number of tokens processed is reduced, which improves processing speed and reduces communication bandwidth usage. Second, the use of structured internal representations (token objects, parse trees, embeddings, feature vectors, indices) and specialized modules (intent classification, emotion estimation, moderation) improves response accuracy and consistency. The system does not merely automate a human teacher's work; it reorganizes the internal data flow and control logic in the server in a way that yields measurable improvements in error rates, response latency, and resource utilization.

In one variation, the server uses a locally hosted generative AI model on the same hardware unit. In such a case, the generative AI interface module calls the model through an internal application programming interface, and the server uses graphics processing units with optimized libraries such as CUDA-like frameworks and deep learning libraries to accelerate matrix operations. The server can adjust batch sizes and scheduling policies to optimize utilization of the hardware resources. The prompt construction and postprocessing logic remain the same, but latency decreases due to elimination of remote network calls. This variation shows how the described architecture is compatible with different deployment configurations while maintaining the same technical advantages.

In another variation, the server employs multiple generative AI models specialized for different subject categories or learning levels. The server maintains a model selection module that chooses an appropriate generative AI model based on the subject information, comprehension index, and achievement index. The server adjusts model-specific parameters, such as model size and decoding strategy, to balance accuracy and computational cost. By coordinating prompt construction with model selection, the server achieves further reductions in computational overhead and improvements in domain-specific accuracy.

The terminal in each embodiment remains relatively simple. The terminal displays the formatted response character string in a dialog-type display region, showing the sequence of user inquiries and system responses in chronological order. The terminal may implement basic user interface enhancements, such as highlighting key terms or providing scroll and copy functions, but the core intelligence resides on the server. This separation of concerns contributes to an efficient architecture where the terminal offloads heavy computation to the server while still enabling responsive, interactive user experiences.

Through these embodiments and variations, the system implements a concrete technical solution that integrates natural language processing, learner profiling, dynamic prompt sentence construction, transformer-based generative AI models, safety and formatting modules, and emotion-aware control. The improved processing pipeline, data structures, and control logic provide technical effects including enhanced accuracy of generated responses, reduced processing time, lower communication bandwidth usage, and improved alignment between generated output and dynamically changing learner states.

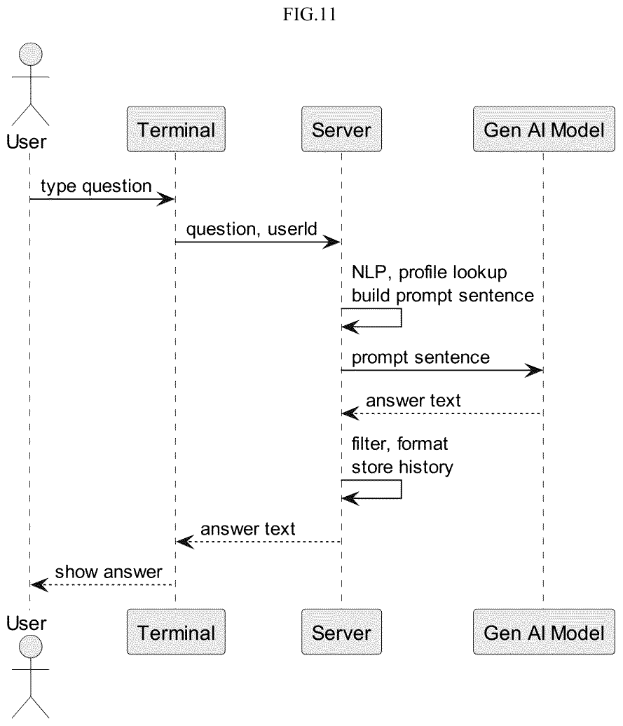

The following describes the processing flow using FIG. 11.

### Step 1

User operates the terminal and opens a chat interface provided by a client application or a web browser.

User inputs an inquiry sentence, for example, “Please explain the process of photosynthesis,” into a text input field and presses a send button.

Terminal receives the user's keystrokes as character data, encodes the string in a character encoding such as UTF-8, and constructs a request object that includes at least a learner identifier and the inquiry text.

Terminal transmits this request object to the server over a network using a communication protocol such as HTTPS.

Input: raw text entered by the user on the terminal.

Output: a structured request message containing the learner identifier and the inquiry text, sent from the terminal to the server.

### Step 2

Server receives the structured request message through a communication interface and stores the raw message temporarily in a memory buffer.

Server parses the message according to a predefined format, such as a JSON or form-encoded structure, and extracts fields including the learner identifier and the inquiry text.

Server validates the extracted data by checking that the inquiry text is not empty and that the learner identifier corresponds to an existing learner record stored in a database.

Server discards malformed or invalid requests, and for valid requests, passes the inquiry text and learner identifier to a natural language processing module.

Input: structured request message from the terminal containing learner identifier and inquiry text.

Output: validated learner identifier and validated inquiry text stored as internal variables for further processing.

### Step 3

Server performs natural language preprocessing on the inquiry text using a natural language processing library.

Server normalizes the text by applying operations such as lowercasing where appropriate, trimming whitespace, and normalizing punctuation.

Server tokenizes the inquiry text into a sequence of tokens and annotates each token with attributes such as token position and part-of-speech tag.

Server executes syntactic analysis to construct a parse tree or dependency structure that represents grammatical relations among tokens.

Server applies semantic analysis and intent estimation by feeding token features and contextual embeddings into an intent classification model to determine the type of request, such as a request for explanation or a request for examples.

Server extracts subject information, such as the concept “photosynthesis,” and learning-purpose information, such as “explain the process,” from the parsed structure and the intent label.

Input: validated inquiry text.

Output: structured linguistic representation including token sequence, parse structure, intent label, subject information, and learning-purpose information.

### Step 4

Server accesses a learner profile management module and queries a storage device for learner attribute information linked to the learner identifier.

Server retrieves attributes such as a learning level, a preferred explanation style, and known areas of interest.

Server also retrieves interaction history records associated with the learner, including previous inquiry texts, previous prompt sentences, and previous responses.

Server computes or updates numerical indices, such as a comprehension index and an achievement index, by applying a predictive model to features derived from the interaction history.

Server combines the explicit learner attributes and the computed indices to derive a current learner profile that indicates an appropriate level of detail, complexity, and style for future responses.

Input: learner identifier and existing learner data stored in the database.

Output: current learner profile containing learning level, preferred explanation style, areas of interest, comprehension index, and achievement index.

### Step 5

Server acquires subject-related information from a knowledge information storage area using the subject information derived from the inquiry.

Server performs a lookup in a knowledge database or index structure to obtain educational content related to the subject, such as short definitions, key concepts, and canonical example explanations.

Server selects and summarizes relevant parts of this subject-related information according to the learner profile, so that advanced learners receive more technical detail and less advanced learners receive more basic explanations.

Input: subject information and learner profile.

Output: subject-related information tailored for the learner, represented as text segments or structured data ready to be embedded in a prompt sentence.

### Step 6

Server constructs a prompt sentence that will be supplied to the generative AI model.

Server first generates a system instruction segment that describes the desired role of the generative AI model, for example:

“You are a friendly biology tutor for high school students.

Explain scientific concepts clearly and accurately using simple English.”

Server then generates a learner-context segment that incorporates the learner's level and preferences, for example:

“The student has a basic understanding of biology.

Use step-by-step explanations and avoid overly technical jargon.”

Server further generates a content segment that encodes the subject-related information and learning-purpose information, for example:

“A student is asking about the topic ‘photosynthesis’.

Please explain the process of photosynthesis step by step.

Describe the roles of light, chlorophyll, carbon dioxide, water, oxygen, and glucose.”

Server finally appends the actual inquiry text in a user-question segment, for example:

“The student's exact question is: ‘Please explain the process of photosynthesis.’”

Server concatenates these segments into a single prompt sentence in character form.

Input: learner profile, subject-related information, and parsed inquiry data.

Output: composed prompt sentence containing system instructions, learner context, content constraints, and the user's actual question.

### Step 7

Server prepares generation request data for the generative AI model by pairing the prompt sentence with generation condition information such as maximum token count, temperature, and top-p value.

Server tokenizes the prompt sentence using a tokenizer compatible with the generative AI model, converting the character string into a sequence of token identifiers.

Server encapsulates the token sequence and generation condition parameters into a request structure and sends this structure to the generative AI model via an internal or external communication interface.

If the generative AI model resides on a remote node, server transmits the request over a network connection using a secure protocol; if the model resides locally, server calls an internal application programming interface.

Input: prompt sentence and generation condition parameters.

Output: generation request containing tokenized prompt and control parameters delivered to the generative AI model.

### Step 8

Server receives a stream or batch of generated tokens from the generative AI model.

Server converts the generated token identifiers back into a character string using the same tokenizer in reverse.

Server accumulates the tokens until an end-of-sequence condition is met or the maximum token limit is reached.

Server treats the resulting character string as a raw response character string that directly reflects the generative AI model's output.

Input: generated token sequence from the generative AI model.

Output: raw response character string constructed from the generated tokens.

### Step 9

Server applies inappropriate-content detection to the raw response character string.

Server converts the response text into features, such as token-level indicators, n-gram patterns, and an embedding vector produced by a classification model.

Server classifies the response as acceptable or not according to a decision boundary learned during training.

If the response is determined to include inappropriate or unsafe content, server either masks or replaces specific segments using deterministic rules, or triggers regeneration by sending an adjusted prompt sentence with stricter stylistic or safety constraints.

Input: raw response character string.

Output: filtered response character string deemed safe or adjusted to remove problematic content.

### Step 10

Server performs expression-format conversion on the filtered response character string.

Server transforms paragraph structure, inserts line breaks, and optionally adds markup tags in accordance with display requirements of the terminal.

Server simplifies complex sentences if the learner profile indicates a lower learning level, by applying syntactic splitting and replacement rules that reduce sentence length and vocabulary difficulty.

Server generates a formatted response character string that is easy to read and appropriately styled for the learner.

Input: filtered response character string and learner profile.

Output: formatted response character string tailored in style and structure to the learner.

### Step 11

Server updates the interaction history using the latest inquiry, prompt sentence, and formatted response.

Server creates a new history record containing the learner identifier, the original inquiry text, the constructed prompt sentence, the formatted response character string, timestamps, and updated comprehension and achievement indices.

Server stores this record in a database table or collection with indexes that allow future retrieval by learner identifier and subject.

Server thereby enriches the dataset used for subsequent optimization of prompt construction and response adaptation.

Input: learner identifier, inquiry text, prompt sentence, formatted response, and updated indices.

Output: persistent interaction history entry stored in the database.

### Step 12

Server sends the formatted response character string to the terminal as part of a response message using a communication protocol such as HTTPS.

Server includes metadata such as a conversation identifier and timestamps in the response message so that the terminal can manage the conversation context.

Terminal receives the response message, decodes it, and extracts the formatted response character string and associated metadata.

Terminal generates a new chat element in the dialog-type display region and renders the formatted response on the display unit, aligning it in chronological order with the user's inquiry.

Input: formatted response character string and metadata from the server.

Output: updated chat display on the terminal showing the user's inquiry and the system's response.

### Step 13

User observes the formatted response on the dialog-type display region of the terminal.

User reads the explanation and determines whether the explanation is sufficient or whether additional clarification is needed.

User may then input a follow-up inquiry, such as “Can you explain photosynthesis in even simpler words?” or “Why is chlorophyll important in photosynthesis?”, using the same text input field.

Terminal again captures the new inquiry as character data, constructs a new structured request message, and sends it to the server.

Input: displayed formatted response and user's understanding state.

Output: optional new inquiry text that restarts the processing flow from Step 1 for a new interaction turn.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented tutoring systems that utilize generative AI models typically accept a user query, pass the raw text or only minimally processed text to a model, and then display the generated output on a terminal. Such systems often treat the generative AI model as a black-box content provider, without systematically structuring input data, without tightly coupling user state to model control, and without managing dialog context as a reusable computational resource. As a result, these systems tend to exhibit unstable answer quality, inconsistent difficulty levels, and limited ability to adapt to each learner over time.

From a computer technology standpoint, there is a need to improve how a processing apparatus generates and controls prompt sentences for a generative AI model, and how the apparatus maintains and exploits dialog history as machine-interpretable context. Existing approaches frequently lack an internal pipeline that transforms a natural language learning request into a rich, structured representation, performs explicit intent classification and difficulty estimation based on stored learner information, and then encodes this information into a prompt sentence in a consistent, machine-optimizable format. Without such a pipeline, the computational resources of the generative AI model are not efficiently utilized, and the system cannot reliably produce outputs that match a learner's comprehension level.

In addition, many known systems do not compute quantitative evaluation indices from past interactions in a form suitable for algorithmic adaptation. They often do not derive a learner-specific comprehension index from measurable system outputs (e.g., reference frequency, follow-up questions, or indicators of completion) and do not feed such indices back into the prompt generation process. This lack of a feedback loop limits the system's ability to self-tune the explanation level and information density at the processor level, and thereby constrains technical performance in terms of stability, personalization, and resource-efficient inference.

Furthermore, conventional systems typically do not integrate emotion estimation into the core computational path that governs the prompt sentence and model behavior. Even when emotion detection is present, it is often treated as a peripheral feature, not as structured control data that reconfigures the generative AI model's output style and content via explicit modifications to the prompt sentence. As a consequence, the system cannot robustly adapt its responses to maintain engagement, adjust pacing, or select additional examples in a manner that is systematically governed by detected emotional states.

Accordingly, there is a need for a computer-implemented system and server-side processing architecture that (i) converts natural language learning requests into structured information, (ii) combines the structured information with learner attributes and dialog history to generate a context-rich prompt sentence for a generative AI model, (iii) computes and maintains learner-specific comprehension indices as machine-usable control parameters, and (iv) incorporates emotion estimation into the generation of prompt sentences so that the generative AI model can be programmatically controlled to produce technically improved, stable, and personalized outputs. Such a system would improve the functioning of the computer itself by organizing data flows, internal state, and model interactions in a way that enhances control over generative AI behavior and yields more consistent, context-aware responses with efficient utilization of computational resources.

The specific processing by the specific processing unit 290 of the data processing device 12 in Application Example 1 is realized by the following means.

The present invention provides a server comprising a processor and a storage device, the processor being configured to receive, from an information terminal operated by a learner, a learning request expressed in natural language and convert the learning request into structured information; to access the storage device to acquire learner information including a learner attribute, a learning history, and a target instructional field based on the structured information and learner identification information; to perform, by executing program instructions, intent classification and difficulty estimation for the learning request based on the acquired learner information; to generate a prompt sentence for input to a generative AI model by integrating, as a text sequence, explanation instruction information including an educational support role, the learner attribute, an explanation level, example conditions, and the learning request in accordance with a result of the intent classification and the difficulty estimation; to encode the prompt sentence into a sequence of units suitable for numerical processing, supply the encoded sequence to the generative AI model executed on a numerical computation device, and cause the generative AI model to generate an answer candidate text; to perform, on the answer candidate text, vocabulary level conversion, description format adjustment, and, when necessary, language conversion in accordance with the learner attribute, thereby generating learning response information; and to store, in the storage device, the learning request, the prompt sentence, and the learning response information as a dialog history, and manage the dialog history as an individual learning context for use in generation of a subsequent prompt sentence and a subsequent answer. This enables the computer system to perform a technically improved control of the generative AI model through structured prompt generation and context management, thereby enhancing stability, personalization, and computational efficiency in producing responses tailored to each learner's comprehension level and interaction history.

The term “processor” refers to a hardware-based or virtual computation unit, such as a central processing unit or a processing core, that executes machine-readable instructions to perform logical operations, numerical operations, and data control operations.

The term “information terminal” refers to an electronic device operated by a learner, such as a mobile communication device, a wearable display device, or a general-purpose computing device, that transmits a learning request to a server and displays a learning response to the learner.

The term “learner” refers to a human user who operates an information terminal and submits a learning request in order to acquire knowledge or skills.

The term “learning request” refers to information expressed in natural language by a learner, including at least one question, command, or topic specification related to an educational subject, and serving as input for further processing by a processor.

The term “natural language” refers to a human language used for everyday communication, such as a spoken or written language, which is not restricted to a formal programming language or a markup language.

The term “structured information” refers to a representation of data that has been converted from natural language into a format with explicit fields or attributes, such as a data structure, a record, or a tagged sequence, enabling systematic processing by a processor.

The term “learner identification information” refers to data that uniquely or quasi-uniquely associates a learning request with a particular learner, such as an identifier, an account ID, or a device-specific token.

The term “learner information” refers to data stored in a storage device that is associated with a learner, including at least a learner attribute, a learning history, and a target instructional field, and that is used to control processing performed by a processor.

The term “learner attribute” refers to profile information related to a learner, such as an age group, an education level, a preferred language, or a subject preference, which is used to adjust an explanation level or vocabulary level.

The term “learning history” refers to data representing past interactions between a learner and a system, including prior learning requests, learning responses, and associated metadata such as timestamps or completion indicators.

The term “target instructional field” refers to a conceptual category of educational content, such as a subject area, a topic, or a curriculum unit, which serves as a basis for selecting or generating instructional material.

The term “information storage device” refers to a memory apparatus, such as a non-volatile storage or a database system, that stores learner information, dialog history, and other data used by a processor.

The term “intent classification” refers to a process in which a processor analyzes a learning request and assigns the learning request to one or more intent categories representing the underlying purpose or information need of the learner.

The term “difficulty estimation” refers to a process in which a processor determines an estimated complexity level or required explanation depth for a learning request, based on at least learner information and content characteristics.

The term “explanation instruction information” refers to control information used to guide generation of an answer, including at least an educational support role, a learner attribute, an explanation level, example conditions, and a learning request.

The term “educational support role” refers to a functional role assigned to a generative AI model, such as a tutor, an instructor, or an assistant, which constrains the style and purpose of generated content.

The term “explanation level” refers to a parameter representing the depth, granularity, or complexity of an explanation, such as introductory, intermediate, or advanced.

The term “example conditions” refers to constraints or requirements for examples to be included in a generated answer, such as a number of examples, a difficulty level of examples, or an application context.

The term “prompt sentence” refers to a text sequence constructed by a processor that is provided as input to a generative AI model and that encodes instructions, constraints, and context for generating an answer.

The term “generative AI model” refers to a machine-learned model, such as a neural network, that receives a prompt sentence as input and generates new text data, including at least a candidate answer, based on learned parameters.

The term “encoding” refers to a process in which a processor converts a prompt sentence into a sequence of units, such as tokens or identifiers, suitable for numerical computation by a generative AI model.

The term “sequence of units” refers to an ordered list of elements, such as tokens, symbols, or indices, that represents a prompt sentence or text in a form used by a generative AI model.

The term “numerical computation device” refers to a hardware or virtual computation environment, such as a processor, a parallel processing unit, or an accelerator, configured to perform numerical operations required for executing a generative AI model.

The term “answer candidate text” refers to a text output generated by a generative AI model in response to a prompt sentence, before any post-processing or adaptation to a learner attribute.

The term “vocabulary level conversion” refers to a process in which words or expressions in an answer candidate text are replaced or adjusted so that the vocabulary matches a target comprehension level associated with a learner.

The term “description format adjustment” refers to a process in which the structure or layout of an answer candidate text is modified, such as by inserting headings, line breaks, or lists, to improve readability and conformity with a desired presentation style.

The term “language conversion” refers to a process in which content in one natural language is transformed into another natural language, such as by translation performed using algorithmic processing.

The term “learning response information” refers to answer data generated or post-processed by a processor, including at least a text explanation and optionally metadata, that is transmitted from a server to an information terminal in response to a learning request.

The term “dialog history” refers to a collection of data representing a sequence of interactions between a learner and a system, including learning requests, prompt sentences, learning response information, and associated metadata.

The term “individual learning context” refers to a subset of dialog history and learner information that is associated with a particular learner and is used as contextual input for generating subsequent prompt sentences and answers.

The term “evaluation indices” refers to quantitative or qualitative measures computed from dialog history, such as reference frequency of output content, types of follow-up questions, and learning completion indicators, for assessing interaction characteristics.

The term “comprehension index” refers to a derived metric associated with a learner, calculated based on evaluation indices, and representing an estimated understanding level of the learner.

The term “voice data” refers to audio signals representing spoken utterances of a learner, captured by an input device and used for analysis by a processor.

The term “text data” refers to character-based information representing content communicated by a learner or a system, including at least typed text, transcribed speech, or generated answers.

The term “acoustic feature extraction processing” refers to an operation in which a processor analyzes voice data to obtain numerical features, such as pitch, energy, or spectral characteristics, used for emotion estimation.

The term “context analysis processing” refers to an operation in which a processor analyzes text data and surrounding dialog information to determine semantic or pragmatic aspects relevant to emotion estimation or intent understanding.

The term “emotion estimation process” refers to a computational procedure that classifies or quantifies an emotional state of a learner based on at least voice data, text data, or derived features.

The term “emotional state” refers to a classification or representation of a learner's emotional condition, such as being positive, neutral, frustrated, or confused, as determined by an emotion estimation process.

The term “encouragement expression” refers to a phrase or wording included in an answer or a prompt sentence that is intended to motivate, reassure, or positively support a learner.

The term “pace adjustment instruction” refers to control information included in a prompt sentence that causes a generative AI model to adjust the speed or density of information delivery, such as by shortening steps, lengthening explanations, or inserting pauses in a dialog.

The term “additional example instruction” refers to control information included in a prompt sentence that causes a generative AI model to include one or more further examples in a generated answer.

The term “expression style” refers to characteristics of generated text, including tone, formality, structure, and use of examples, as controlled by information contained in a prompt sentence.

In one embodiment, a server, one or more terminals, and a communication network cooperate to implement the system. The server includes at least one processor, a main memory, a non-volatile storage device, and a network interface. The terminal includes at least one processor, a display, an input device such as a touch panel or microphone, a memory, and a communication module. The user operates the terminal to issue learning requests and to receive learning response information from the server.

The server executes an operating system such as a general-purpose server operating system and runs middleware including a web application framework, a database management system, and a machine learning inference framework. The server uses a programming language environment such as a high-level scripting environment to coordinate modules that implement natural language processing, prompt sentence generation, generative AI model inference, dialog history management, and learner state estimation. The server stores learner information, dialog history, and model configurations in the non-volatile storage device, for example in the form of relational tables managed by a database engine.

The terminal executes a client application, such as a web browser or a native application, which presents a user interface to the user. The terminal displays an input field into which the user can enter a natural language learning request by keyboard input, touch-screen input, or voice input. The terminal converts the user's speech into text by executing a local speech recognition module or by using an external speech-to-text service, and stores the resulting text in a local memory buffer. The terminal then transmits the learning request text, together with learner identification information, to the server via the communication network using a secure transport protocol.

The server receives the learning request and performs natural language preprocessing using a natural language processing library such as a tokenization and syntactic analysis library. The server segments the learning request into tokens, assigns part-of-speech tags, and identifies candidate key phrases related to a subject area, such as differentiation, Newton's law, or eigenvalues. The server then maps these key phrases to a target instructional field using a stored mapping table held in the database, thereby associating the learning request with a particular subject area.

The server retrieves learner information from the storage device by querying a learner profile table using the learner identification information. The learner information typically includes a learner attribute (for example, an age range and an education level), a preferred language, and a learning history that contains records of past questions, generated answers, and completion flags. The server converts the retrieved learner information, the tokenized learning request, and the subject area mapping into a structured internal representation, for example an object or record that includes fields for raw text, normalized text, subject code, learner attribute code, and history references.

The server performs intent classification and difficulty estimation using a classifier and a regressor or multi-class predictor implemented as machine learning models. The server may use a lightweight neural network or another statistical model trained in advance on labeled educational queries. The server feeds feature vectors derived from the tokenized learning request, the subject area identifier, and the learner attribute into the classifier. The feature vectors may include term frequency-inverse document frequency values, word embeddings, or sentence embeddings computed by a pre-trained language encoder. The server obtains an intent label, such as “basic_concept_explanation”, “problem_solution”, or “definition_request”, and a difficulty level indication, such as “introductory”, “intermediate”, or “advanced”.

The server generates a prompt sentence for a generative AI model using a deterministic template and rule set. The server constructs the prompt sentence by combining (i) an educational support role description, (ii) a description of the learner attribute, (iii) an explicit explanation level instruction derived from the difficulty estimation, (iv) example conditions that specify the number and type of examples, and (v) the normalized learning request text itself. The server constructs these components as text fragments and concatenates them in a fixed order with explicit delimiters, thereby producing a prompt sentence with a predictable structure that can be tuned and optimized.

For example, the server may generate one of the following prompt sentences:

“You are an AI tutor that explains concepts clearly and step by step. The learner is a high school student studying basic calculus. Explain the basics of differentiation, starting from the idea of rate of change, and give one simple numerical example. The user asked: ‘Teach me the basics of differentiation.’”

“You are an AI tutor. The learner is a junior high school student learning introductory physics. Explain Newton's second law (F=ma) in very simple terms and give two everyday examples. The user asked: ‘What is Newton's second law?’”

“You are an AI tutor for university-level linear algebra. The learner knows basic matrices but not eigenvalues. Define an eigenvalue and eigenvector, and show one 2×2 matrix example with full calculation. The user asked: ‘What is an eigenvalue?’”

The server encodes the prompt sentence into a sequence of units for numerical computation. The server uses a tokenizer associated with the generative AI model, such as a subword tokenizer, to segment the prompt sentence into tokens and convert them into integer indices. The server arranges these indices into a fixed-or variable-length sequence and, if necessary, pads or truncates the sequence according to the maximum input length supported by the generative AI model. The server then transfers the sequence of indices to a numerical computation device, such as a graphics processing accelerator or a tensor processing accelerator, where the generative AI model is executed.

The server implements the generative AI model as a neural network, for example a transformer-based sequence model with a stack of self-attention layers and feed-forward layers. The server loads trained model parameters from the storage device into the memory of the numerical computation device. During inference, the server performs a forward pass through the network: the server converts token indices into embedding vectors, computes multi-head self-attention using learned weight matrices, applies non-linear activation functions, and propagates the representations through multiple layers. The server then applies a linear output layer and a softmax function to obtain probability distributions over possible next tokens.

The server generates an answer candidate text using a decoding algorithm, such as greedy decoding or top-k sampling. The server iteratively selects or samples the next token based on the output distribution at each time step and appends the token to the output sequence until an end-of-sequence token is produced or a maximum length is reached. The server decodes the resulting token sequence back into text using the same tokenizer in reverse. The server thus obtains the answer candidate text as a natural language response corresponding to the original learning request, now enriched by the structure provided in the prompt sentence.

The server performs post-processing on the answer candidate text. The server first checks the language of the answer candidate text and, when necessary, performs language conversion using a translation model or external translation module so that the response matches the learner's preferred language. The server then executes vocabulary level conversion by examining the frequency and complexity of words in the answer candidate text and replacing or simplifying terms that exceed a target complexity threshold for the learner attribute. The server uses a vocabulary mapping table that associates high-level technical terms with more basic equivalents. The server further applies description format adjustment by inserting headings, numbered steps, or bullet points according to the intent classification; for example, the server uses stepwise formatting for “procedure_explanation” intents and descriptive paragraphs for “basic_concept_explanation” intents.

The server generates learning response information that includes the processed answer text and associated metadata, such as the subject area, explanation level, and timestamp. The server stores the learning request, the generated prompt sentence, and the learning response information in the storage device as dialog history. The server organizes the dialog history as a sequence of records indexed by learner identification information and interaction time, and may also maintain summary statistics for each learner, such as the number of questions per subject and the proportion of follow-up questions.

The server computes evaluation indices based on the dialog history. The server measures reference frequency, for example, by counting how many times the user re-views a particular response or related content if the interface supports such behavior, types of follow-up questions by categorizing new queries that refer to prior responses, and learning completion indicators by monitoring confirmations or quiz results stored in the history. The server aggregates these indices over a plurality of interactions and calculates a comprehension index for each learner. The server then uses the comprehension index to adjust the explanation level and the amount of information included in future prompt sentences, for example by instructing the generative AI model to provide more concise explanations and fewer examples if the comprehension index reaches a high threshold.

The server optionally performs emotion estimation based on voice data and text data from the learner. The server extracts acoustic features such as pitch, energy, and spectral coefficients from voice data. The server also computes text features such as sentiment scores or the presence of specific phrases associated with frustration or confusion. The server feeds these features into an emotion classification model, which may be a neural network trained using supervised learning with labeled emotion categories. The server classifies the emotional state of the learner and encodes the state as a control signal. The server then modifies subsequent prompt sentences by including an encouragement expression, a pace adjustment instruction, or an additional example instruction. For example, the server may append text such as “Encourage the learner and slow down the explanation, using simpler steps and more reassurance” when the emotional state indicates confusion or frustration. This results in a controlled change in the behavior of the generative AI model at the level of textual instructions, rather than an ad hoc post-edit of the final answer.

The server thereby implements a non-conventional, rule-based pipeline for prompt sentence generation and model control that differs from mere human emulation. The server uses explicit internal data structures and control rules: the prompt sentence template, the mapping from learner attributes and comprehension index to explanation level, the emotion-to-instruction mapping, and the vocabulary conversion rules. These components interact in a deterministic and machine-optimizable way, enabling the generative AI model to be driven as a configurable computation engine rather than as a black box that simply responds to raw human queries.

The server provides several technical effects. By structuring the learning request and learner information into a rich prompt sentence and by maintaining an individual learning context, the server reduces the variance in model outputs and improves the accuracy of difficulty matching, which leads to fewer unnecessary follow-up queries. Because the generative AI model receives more precise control signals, the server can often generate suitable answers in fewer decoding steps and with less token generation, thereby reducing computation time and resource usage on the numerical computation device. By caching dialog histories and derived comprehension indices, the server reduces redundant processing of basic questions and can bypass long explanations when a learner has already demonstrated proficiency, which further decreases processing load and network traffic between the server and terminals.

The server also improves data management by storing prompt sentences and answers in a structured form, which enables efficient retrieval and analysis. The server can reuse previously generated responses or response patterns when similar learning requests are detected, applying only limited adaptation through vocabulary conversion or formatting. This reuse decreases the number of full inferences required from the generative AI model and contributes to computational efficiency. The system thus enhances the functioning of the computer architecture itself, in terms of processing speed, storage efficiency, and communication load, rather than merely automating a human tutor's activities.

In another embodiment, the server uses a different neural network architecture, such as a recurrent neural network or an encoder-decoder network with attention, instead of a transformer-based model. The server trains the generative AI model using supervised learning on paired prompt-answer datasets and applies a loss function such as cross-entropy. The server updates the model parameters by executing a gradient-based optimization algorithm on a training platform, possibly separate from the inference server. The server may perform data augmentation during training by paraphrasing learner questions, varying example conditions, or adding noise to text, thereby increasing robustness. The trained model is then deployed to the inference server and used within the same prompt sentence control framework described above.

In yet another embodiment, the server divides the generative AI model into a smaller local model and a remote large-scale model. The server executes the smaller model on a local processor for fast, low-cost responses to simple learning requests, and selectively forwards more complex requests to the larger model. The server determines which model to use based on the intent classification, difficulty estimation, and comprehension index. This architecture reduces average latency and decreases network load to external resources, while still providing high-quality responses when necessary.

The terminal may also be configured in alternative forms, such as a head-mounted display or a mixed reality device. The terminal then overlays the learning response information onto a physical environment, for example by displaying mathematical derivations near an object being studied. The server, in this case, generates additional metadata in the learning response information, such as spatial layout instructions, which the terminal uses to position text in three-dimensional space. This configuration illustrates that the system is not limited to purely abstract information processing, but provides concrete control of display hardware to present adaptive educational content in a spatially meaningful manner.

The user uses the system by operating the terminal to issue successive learning requests and to observe adaptive responses from the server. Over time, the server refines the comprehension index and emotion-responsive control signals, thereby modifying internal model usage patterns, prompt sentence content, and output formatting rules. The server thus implements a novel, computer-centric improvement in the way generative AI models are orchestrated and controlled, enabling more accurate, efficient, and stable operation of the underlying hardware and software components across multiple embodiments.

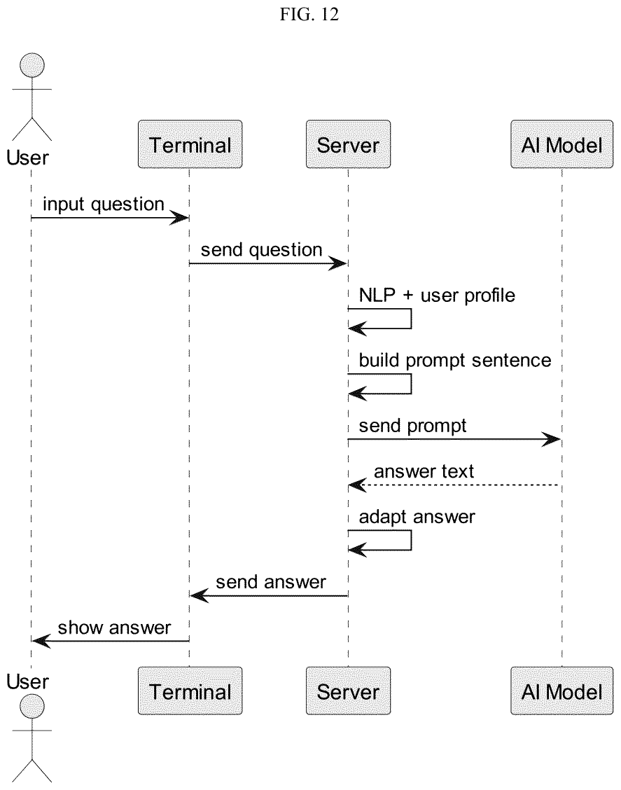

The following describes the processing flow using FIG. 12.

### Step 1

The user operates the terminal and opens an educational application. The terminal displays an input field and a send control. The user inputs a learning request in natural language, for example “Teach me the basics of differentiation,” using a keyboard, touch screen, or microphone. The terminal receives the raw character sequence or speech waveform as input. The terminal converts speech to text when necessary, packages the text together with learner identification information as structured data, and outputs a request message that is transmitted to the server over a communication network.

### Step 2

The server receives the request message from the terminal via a network interface. The server takes the request message as input, parses the message to extract the learning request text and the learner identification information, and validates that the data format is correct. The server logs the raw input into a logging subsystem and outputs a normalized internal request object that contains at least the plain text of the learning request and an identifier associated with the learner.

### Step 3

The server accesses a storage device using the learner identifier contained in the internal request object. The server uses the learner identifier as input to a database query and retrieves learner information including a learner attribute, a preferred language, and a learning history. The server combines the learning request text and the retrieved learner information into a structured record, for example by assigning the data to fields such as “request_text,” “subject_candidate,” “age_group,” and “education_level.” The server outputs this structured record as input to subsequent natural language analysis modules.

### Step 4

The server performs natural language preprocessing on the learning request text contained in the structured record. The server receives the raw text string as input, applies tokenization to split the text into word units, assigns part-of-speech tags, and detects key phrases using a natural language processing library. The server may compute vector representations such as word embeddings. The server uses these processed tokens and vectors to infer a subject area and maps it to a target instructional field using a stored mapping table. The server outputs an augmented structured record that now contains tokens, linguistic tags, and a subject area code.

### Step 5

The server executes an intent classification and difficulty estimation module. The server uses the tokens, subject area code, and learner attribute from the augmented record as input features. The server converts these features into numerical vectors and feeds the vectors into a trained classifier and regressor. The server performs matrix multiplications and non-linear activations to compute an intent label, such as “basic_concept_explanation,” and a difficulty level, such as “introductory.” The server writes the intent and difficulty level into the structured record and outputs an intent-annotated record that is used to control later processing.

### Step 6

The server generates a prompt sentence for a generative AI model. The server uses the intent-annotated record, including the learner attribute, subject area, difficulty level, and original learning request text, as input. The server selects template fragments corresponding to an educational support role, an explanation level, and example conditions, and replaces placeholders with the learner-specific values. The server concatenates the fragments and the learning request text into a unified prompt sentence string. For example, the server may output the prompt sentence: “You are an AI tutor that explains concepts clearly and step by step. The learner is a high school student studying basic calculus. Explain the basics of differentiation, starting from the idea of rate of change, and give one simple numerical example. The user asked: ‘Teach me the basics of differentiation.’”

### Step 7

The server encodes the prompt sentence into a sequence suitable for numerical computation. The server takes the prompt sentence string as input and applies a tokenizer associated with the generative AI model to segment the text into tokens and map each token to an integer index. The server arranges the indices into an ordered array and applies padding or truncation if needed. The server outputs a sequence of token indices as the formatted input to the generative AI model.

### Step 8

The server forwards the token index sequence to the generative AI model executing on a numerical computation device. The server uses the token index sequence as input to the model's inference routine. The generative AI model, implemented for example as a transformer network, performs embedding lookups, multi-head attention, and feed-forward layer computations using stored weight parameters. The server iteratively computes probability distributions over the vocabulary for each time step and applies a decoding algorithm such as greedy decoding or top-k sampling to select output token indices. The server stops when an end-of-sequence symbol is generated or a maximum length is reached, and outputs a generated token index sequence representing an answer candidate.

### Step 9

The server decodes the generated token index sequence into natural language text. The server takes the generated indices as input and applies the tokenizer's decoding function to map indices back to tokens and to reconstruct a text string. The server removes special tokens and corrects spacing or punctuation as part of this post-processing. The server outputs the answer candidate text, which is a coherent natural language response to the original learning request.

### Step 10

The server adapts the answer candidate text to the learner's profile. The server uses the answer candidate text, together with the learner attribute and preferred language from the structured record, as input. The server checks the language of the candidate text and, when necessary, invokes a translation module to convert the text into the learner's preferred language. The server then performs vocabulary level conversion by scanning for complex terms and replacing them with simpler synonyms stored in a vocabulary conversion table. The server further applies description format adjustment by inserting headings, step markers, or bullet points in accordance with the intent label. The server outputs a finalized learning response text and associated metadata such as subject area and explanation level.

### Step 11

The server constructs a learning response message and transmits it to the terminal. The server takes the finalized learning response text and metadata as input, assembles them into a response structure, and serializes the structure for network transmission. The server uses the network interface to send the response message to the terminal. The server also logs the response and writes the learning request, the prompt sentence, and the learning response text into a dialog history data structure stored in the storage device. The server outputs an updated dialog history record linked to the learner identifier.

### Step 12

The terminal receives the learning response message from the server via the communication module. The terminal uses the incoming message as input, deserializes the message to extract the learning response text and metadata, and writes them into local memory. The terminal updates the user interface by inserting the learning response text into a display area, possibly adding visual formatting based on the metadata. The terminal outputs the rendered content to the display, allowing the user to read the answer.

### Step 13

The server periodically analyzes the accumulated dialog history to compute evaluation indices. The server uses multiple dialog records associated with a learner as input, calculates statistics such as reference counts, types of follow-up questions, and occurrence of completion indicators, and combines these values into an evaluation vector. The server applies a predetermined algorithm, for example a weighted sum or a learned regression, to convert the evaluation vector into a comprehension index that quantitatively represents the learner's understanding level. The server writes the comprehension index back into the learner information and outputs an updated learner profile, which will be referenced when generating subsequent prompt sentences.

### Step 14

The server optionally performs emotion estimation using voice data and text data from the learner. The server accepts as input acoustic features extracted from recorded speech and textual features derived from recent learning requests. The server feeds these features into an emotion classification model that computes probability scores for multiple emotional categories. The server selects the category with the highest score as the current emotional state and encodes this as a control flag. The server outputs this control flag and, in later prompt generation steps, appends corresponding instructions such as “Encourage the learner and slow down the explanation” or “Provide additional examples” to the prompt sentence, thereby influencing how the generative AI model will generate subsequent answers.

### Step 15

The user reviews the displayed learning response on the terminal and decides whether additional clarification is necessary. The user uses the learning response as input for forming a new learning request, for example by asking a follow-up such as “Please show another example of differentiation.” The user enters the follow-up request through the terminal's input interface. The terminal receives the new text, associates it with the same learner identifier, and outputs another request message to the server. The overall sequence of operations then repeats, with the server now using the updated dialog history and comprehension index to generate a new, context-aware prompt sentence and refined answer.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented educational support systems generally rely on static content retrieval or rule-based response generation. Such systems typically retrieve pre-authored explanations or apply fixed templates in response to learner queries. As a result, these systems often fail to adapt to the learner's current level of understanding, emotional state, or evolving learning context, and therefore provide suboptimal guidance. In particular, when a user repeatedly submits prompt sentences on related topics, conventional systems do not effectively leverage the accumulated interaction history, and consequently cannot refine the difficulty, depth, or style of subsequent explanations in a systematic manner.

Furthermore, when generative AI models are employed in a naïve way, the surrounding computer infrastructure is not configured to make efficient and reliable use of such models. For example, generic server applications may simply forward raw prompt sentences to a model endpoint and return raw model outputs to a terminal without appropriate input normalization, output post-processing, or dynamic control of model parameters. This can lead to responses that are excessively long or short, poorly formatted, or misaligned with the user's comprehension level and emotional state. These deficiencies degrade the usability and educational effectiveness of the system and can increase computational load and network traffic, because users are forced to submit additional clarification prompts.

Moreover, conventional client-server architectures often treat the terminal as a passive display endpoint that merely shows model outputs, without coordinating the user interface behavior with the server-side analysis of interaction history and user state. As a consequence, conversation histories are not systematically associated with individual response generations, and the interface does not guide the user toward effective follow-up prompt sentences. This fragmentation between server-side generative processing and terminal-side interaction handling prevents the overall computer system from achieving robust, adaptive, and efficient interactive learning.

Accordingly, there is a need for an improved computer-implemented system and server-side control technique that (i) systematically converts user prompt sentences into structured model input data, (ii) dynamically adjusts the behavior of a generative AI model in view of past interaction data and inferred user emotional state, (iii) post-processes generated responses to enforce length, formatting, and content constraints, and (iv) coordinates with a terminal-side user interface to maintain a coherent learning history and support continuous, interactive learning. Such a system should improve the functioning of the underlying computer technology by providing more predictable and controllable use of generative AI models, reducing unnecessary computation and network round-trips, and enhancing the effectiveness of the human-computer interaction loop.

The specific processing by the specific processing unit 290 of the data processing device 12 in Example 2 is realized by the following means.

The present invention provides a server comprising a processor configured to receive, via a communication interface, structured information corresponding to a prompt sentence expressed in natural language and transmitted from a terminal device, to analyze the structured information together with user attribute information stored in a storage device, to generate model input data for a generative AI model based on the analysis, to provide the model input data to the generative AI model executed by a model execution component so as to cause the generative AI model to generate a response sentence in natural language, to perform post-processing on the response sentence by applying at least one of length control, formatting, and content filtering implemented by a post-processing module, to store the post-processed response sentence in association with interaction history data in the storage device, and to transmit the post-processed response sentence and associated interaction history data to the terminal device for display by a user interface component. This enables the computer system to exercise fine-grained control over the use of the generative AI model, to adapt the generated responses to user-specific comprehension and emotional characteristics, to reduce redundant user interactions and computational overhead, and to provide a coherent, interactive learning experience that improves the overall operation of the server-terminal architecture.

The term “system” refers to an arrangement of one or more hardware devices and software components that cooperate via one or more communication networks to execute the processing described in the claims.

The term “processor” refers to one or more hardware processing units, such as a central processing unit or graphics processing unit, configured by executable instructions to perform arithmetic, logical, control, and input/output operations for implementing the functions described in the claims.

The term “user” refers to a human individual who interacts with the system by providing input data and receiving output data for the purpose of learning or obtaining information.

The term “user terminal” refers to an information processing device operated by the user, such as a mobile device, a personal computer, or a tablet device, that provides a user interface for inputting prompt sentences and displaying response sentences.

The term “prompt sentence” refers to a sequence of characters expressed in natural language and input by the user, which indicates a request, question, or instruction for generating information by the generative AI model.

The term “natural language” refers to a human language used for general communication, such as a spoken or written language, as opposed to a programming language or a formal markup language.

The term “structured information” refers to data that represents at least a portion of a prompt sentence and related metadata in a predefined format, such as key-value pairs or fields, enabling systematic processing by a program.

The term “communication network” refers to a wired or wireless communication infrastructure, including the Internet, local area networks, or wide area networks, through which data is transmitted between the user terminal and the server.

The term “information processing apparatus” refers to a hardware device or combination of devices including at least one processor and a memory, configured to execute computer programs for processing data exchanged with the user terminal and the generative AI model.

The term “user attribute information” refers to data related to characteristics of the user, such as a user identifier, language preference, learning level, or past usage information, which is stored and referenced to control system behavior.

The term “model input data” refers to a structured representation of information that is provided as input to the generative AI model, including at least the content of a prompt sentence and, optionally, instructions, parameters, or contextual information.

The term “generative AI model” refers to a machine-learned model that receives model input data and generates output data, including natural language text, by probabilistically predicting sequences based on patterns learned from training data.

The term “response sentence” refers to a sequence of characters expressed in natural language that is generated by the generative AI model in response to model input data derived from a prompt sentence.

The term “post-processing” refers to processing performed on the response sentence after generation by the generative AI model, including modification, selection, or reformatting of the response sentence according to predetermined rules.

The term “length control” refers to processing that adjusts or constrains the length of a response sentence, such as truncating, expanding, or otherwise modifying the response sentence to satisfy length-related conditions.

The term “formatting” refers to processing that changes or adds presentation structure to a response sentence, such as inserting headings, line breaks, lists, or other layout elements to improve readability.

The term “content filtering” refers to processing that evaluates and modifies a response sentence to remove, mask, or adjust portions of content that do not satisfy predetermined content criteria.

The term “post-processed response sentence” refers to a response sentence that has undergone at least one of length control, formatting, or content filtering after being output from the generative AI model.

The term “display device” refers to a hardware component, such as a screen or monitor, capable of visually presenting text or graphical elements to the user.

The term “learning history” refers to data representing a record of past interactions between the user and the system, including past prompt sentences, response sentences, timestamps, and associated metadata.

The term “user interface” refers to software-controlled presentation elements and input controls on the user terminal that enable the user to view response sentences and input further prompt sentences.

The term “past interaction data” refers to stored data representing previous exchanges between the user and the system, including at least prompt sentences and response sentences, and optionally associated attributes such as time or topic.

The term “comprehension index” refers to a quantitative or qualitative indicator derived from past interaction data and representing an estimated level of the user's understanding or proficiency.

The term “instruction content” refers to portions of the model input data that specify how the generative AI model should behave, including constraints, roles, or style guidelines for generating the response sentence.

The term “generation parameter” refers to a control value used by the generative AI model during generation, such as a temperature value, maximum token count, or other model-specific parameter influencing output characteristics.

The term “voice data” refers to digital data representing audio signals produced by the user's speech, obtained via a microphone or other audio input device.

The term “text data” refers to digital data representing characters or strings input or generated in written form, including prompt sentences and other user-provided textual content.

The term “emotional state” refers to an inferred affective condition of the user, such as being confused, confident, frustrated, or interested, estimated based on analysis of voice data, text data, or combinations thereof.

The term “model execution component” refers to a hardware or software module that executes the generative AI model, including performing computations necessary to generate response sentences from model input data.

The term “post-processing module” refers to a hardware or software module that performs post-processing operations on response sentences output by the generative AI model.

The term “storage device” refers to a hardware component, such as a memory or a storage medium, that stores user attribute information, interaction history data, model input data, response sentences, and configuration data.

The term “interaction history data” refers to stored information that cumulatively records interactions between the user and the system, including at least prompt sentences, response sentences, and related metadata over time.

The term “user interface component” refers to a software module executed on the user terminal that manages input controls and display elements for interacting with the user, including presenting the learning history and enabling continuous input of prompt sentences.

The term “formatting policy” refers to a set of rules or parameters that determine how a response sentence is to be arranged or styled during post-processing for presentation to the user.

In one embodiment, a server executes an educational support application that cooperates with one or more terminals operated by users. The server includes at least one processor, a main memory, a non-volatile storage device, a network interface, and optionally one or more hardware accelerators such as graphics processing units. The server runs an operating system such as a server-class operating system on general-purpose hardware including, for example, a multi-core central processing unit, dynamic random-access memory, and solid-state storage. The server hosts a generative AI model implemented as a neural network executed by a machine learning framework such as a tensor-based computation library, and exposes an application programming interface to the terminals over a communication network.

The terminal operates as a client device. The terminal includes a processor, a memory, a display device, an input device such as a touch panel or keyboard, and a communication interface for accessing the server via a wired or wireless network. The terminal runs a client program implemented as a native application or a web application using a browser. The terminal provides a user interface for receiving a prompt sentence in natural language from the user, encoding the prompt sentence into structured information, and displaying a response sentence received from the server.

The user interacts with the terminal by entering a prompt sentence in natural language that expresses a request for educational information. For example, the user may input the following prompt sentence:

“Explain the main events of the French Revolution in about 300 words.”

The user may also input other prompt sentences such as:

“Explain the main themes of Hamlet in simple English and give three short example quotes.”

“Act as a tutor for a middle-school student. Explain the causes of World War I using clear and simple language, and then ask two follow-up questions to check understanding.”

“Summarize the concept of photosynthesis for a university-level biology course, including the light-dependent and light-independent reactions, in about 400 words.”

“Create a step-by-step explanation of how to solve quadratic equations using the quadratic formula, with one worked example and one practice problem.”

The terminal converts the user's prompt sentence into structured information. The terminal represents the prompt sentence as a string in a standard text encoding and associates the string with metadata such as a user identifier, a language code, a timestamp, and a session identifier. The terminal stores this information in a data structure in memory, for example a record that includes separate fields for the prompt text and each element of metadata. The terminal then transmits this structured information to the server via the communication interface using a protocol such as a secure hypertext transfer protocol.

The server receives the structured information and stores it temporarily in main memory. The server executes an input analysis module that normalizes the prompt sentence and associated metadata. The server, for example, applies tokenization rules to segment the prompt sentence into tokens, normalizes whitespace, and converts characters to a canonical form. The server stores these normalized tokens in an internal data structure optimized for fast access by the generative AI model. The server also retrieves user attribute information from a storage device, including a learning level, a preferred language, and a record of past interaction data.

The server uses the processor to construct model input data for the generative AI model. The server includes in the model input data at least the normalized prompt sentence and optionally additional instruction content that controls the behavior of the generative AI model. For example, the server inserts instruction content specifying that explanations should match a high-school level or a middle-school level, depending on the user attribute information and a computed comprehension index. The server further includes generation parameters such as a maximum token count, a temperature parameter, and a top-probability parameter that control the sampling behavior of the generative AI model.

The server implements the generative AI model as a neural network having a transformer-based architecture. The server stores, in a model storage region of the storage device, model parameters including weight matrices and bias vectors for each layer. The server loads these model parameters into memory and, when available, into GPU memory. The server organizes the model as multiple layers including an input token embedding layer, positional encoding, a plurality of self-attention layers, feed-forward layers, and an output projection layer. The server uses a tokenizer to map the prompt sentence tokens in the model input data to integer token identifiers. The server then uses the processor or GPU to perform matrix multiplications, attention weight computations, and non-linear activation functions for each layer of the model.

The server trains the generative AI model in advance on a large corpus of text data. The server uses a learning algorithm such as stochastic gradient descent or a variant thereof, and applies a loss function such as cross-entropy between predicted token distributions and ground-truth token labels. The server updates the model parameters by computing gradients of the loss function with respect to each weight and bias, using backpropagation across the transformer layers. The server optionally performs data augmentation during training by applying transformations to the training text data such as random masking or paraphrasing. The server stores the trained model parameters in the storage device for later inference.

During inference, the server computes, for each position in the output sequence, a probability distribution over the vocabulary of tokens. The server uses a decoding algorithm such as greedy selection, beam search, or nucleus sampling with the specified top-probability parameter and temperature. The server accumulates the selected tokens as an output token sequence and stops when reaching a special end-of-sequence token or when the maximum token count is reached. The server then converts the output tokens back into a response sentence in natural language using the tokenizer's detokenization procedure.

The server applies post-processing to the generated response sentence using a post-processing module. The server performs length control by checking the number of characters or tokens in the response sentence and truncating or summarizing the content if the length exceeds a threshold. The server applies formatting rules that insert line breaks, headings, or lists according to a formatting policy designed for educational readability. The server also applies content filtering rules that remove or modify sections that do not match the requested subject or that are detected as off-topic or inappropriate under system policies. The server associates the post-processed response sentence with the corresponding prompt sentence and metadata in an interaction history data structure stored in the storage device.

The server maintains, in the interaction history data structure, a sequence of records, each record including a prompt sentence, a response sentence, timestamps, and indicators of user outcomes such as whether the user requested a follow-up explanation. The server analyzes this interaction history to compute a comprehension index for the user. The server, for example, counts occurrences of clarification-type prompt sentences, computes an average reading time based on timestamps, and analyzes the linguistic complexity of the user's prompt sentences using features such as sentence length and vocabulary diversity. The server aggregates these features into a numerical score representing the user's comprehension level.

The server uses the comprehension index to modify subsequent model input data. For example, when the comprehension index indicates a low understanding level, the server inserts instruction content that specifies shorter sentences, simpler vocabulary, and more step-by-step explanations. When the comprehension index indicates a high understanding level, the server inserts instruction content that specifies more detailed analysis and more advanced terminology. The server also adjusts generation parameters such as maximum token count and temperature to control the complexity and variability of the generated responses. This dynamic adjustment of model input data and generation parameters enables the server to tailor the generative AI model's behavior to the user's current state.

The server optionally estimates an emotional state of the user from voice data or text data. When the terminal transmits audio data representing the user's speech, the server applies an audio feature extraction algorithm that computes features such as pitch, energy, and spectral characteristics. The server then applies an emotional classification model, which may be a separate neural network trained with a loss function such as categorical cross-entropy, to assign an emotional label such as frustrated, confused, or confident. When the terminal transmits only text data, the server computes textual features such as sentiment scores, presence of exclamation marks, or expressions associated with confusion. The server uses these features as input to a text-based emotional classifier implemented as a neural network or a statistical model.

The server uses the estimated emotional state to modify the conditions of the model input data and the formatting policy of the post-processing module. For example, when the emotional state indicates confusion, the server instructs the generative AI model to produce more reassurance, to use simpler language, and to include explicit step-by-step reasoning in the response sentence. When the emotional state indicates confidence, the server instructs the generative AI model to focus on more advanced topics or challenge questions. The server may also adjust formatting to include additional highlighting or emphasis for key points when confusion is detected. These modifications follow rule sets implemented in the server code and are applied systematically, rather than being ad hoc human decisions.

The terminal receives the post-processed response sentence and the associated interaction history data and stores them in memory. The terminal controls the user interface to present the response sentence on the display device. The terminal arranges the response sentence and the prompt sentence in a conversation view that visually associates each response with the corresponding prompt. The terminal additionally displays portions of the learning history, allowing the user to scroll through past exchanges. The terminal provides controls such as buttons or text fields that enable the user to enter further prompt sentences or to change learning preferences.

The system provides technical improvements over conventional approaches by tightly integrating the generative AI model with structured input conversion, dynamic parameter control based on computed indices, systematic post-processing, and coordinated user interface management. Because the server converts free-form prompt sentences into structured model input data with explicit instruction fields and tuned generation parameters, the generative AI model produces more predictable output lengths and styles. As a result, the server reduces unnecessary repeated requests from the terminal and saves computational resources. The dynamic control of maximum token count and sampling parameters reduces average response size, thus lowering network traffic and improving response time.

The server's use of interaction history and computed comprehension indices improves data management within the computer system. The server maintains a structured log that links each output to specific input conditions and user states. This structure enables the server to reuse learned patterns about a user's needs when processing future requests, thereby reducing redundant computation. The post-processing module, by enforcing length and format constraints, simplifies rendering on the terminal and reduces client-side processing load. The coordinated adjustment of formatting policies according to emotional state and comprehension level also reduces the need for additional round-trip clarifications.

The system does not merely automate a human tutor's task. The server employs non-conventional rules and procedures that are specific to the operation of computers and neural networks. The server, for example, controls the internal behavior of the transformer-based generative AI model by programmatically adjusting generation parameters for each individual request. Human tutors cannot modify a neural network's temperature or beam width, nor can they perform real-time probabilistic decoding or attention-weighted matrix multiplications. The server, in contrast, uses the processor and machine learning framework to alter low-level computational behavior in response to measured user state, thereby changing how the underlying computation proceeds and improving technical performance metrics such as inference latency and resource utilization.

The neural network architecture and training procedure further contribute to technical improvements. The server, by training the generative AI model with an error function and optimization algorithm, adjusts model parameters to reduce prediction error over a large training corpus. This learning process produces a model that can generate coherent, contextually adapted responses quickly at inference time, without the need for retrieving and joining multiple static documents. The ability to generate contextually appropriate answers in a single pass through the neural network reduces disk access, database joins, and additional network fetches that would otherwise be necessary in a purely retrieval-based system.

In alternative embodiments, the server may use different neural network architectures, such as recurrent neural networks or encoder-decoder architectures, or may use a mixture of retrieval-based and generative components. The server may replace the transformer layers with other attention mechanisms or may include specialized modules for handling mathematical expressions or domain-specific terminology. The server may also deploy the generative AI model on different hardware configurations, such as a multi-node cluster with model parallelism, or on specialized inference accelerators.

In another embodiment, the terminal performs additional preprocessing of the prompt sentence, such as local spelling correction or language detection, before sending the structured information to the server. In yet another embodiment, the server performs partial rendering of formatting elements, such as converting response sentences with markup into a compact representation that the terminal can efficiently render. In further embodiments, the server compresses the post-processed response sentences before transmission, thereby reducing bandwidth consumption and further improving response times.

Because the system structures data, controls computational parameters, manages interaction history, and coordinates user interface behavior in a specific way tailored to the generative AI model, the system improves the functioning of the underlying computer infrastructure. The server reduces unnecessary compute cycles by calibrating generation length and style based on user state, the server and terminal reduce network load through optimized response sizes, and the user interface improvements decrease user confusion and the number of redundant interactions. These technical effects arise from the particular organization of data structures, control logic, and neural network configuration described above, and not merely from automating an abstract educational process.

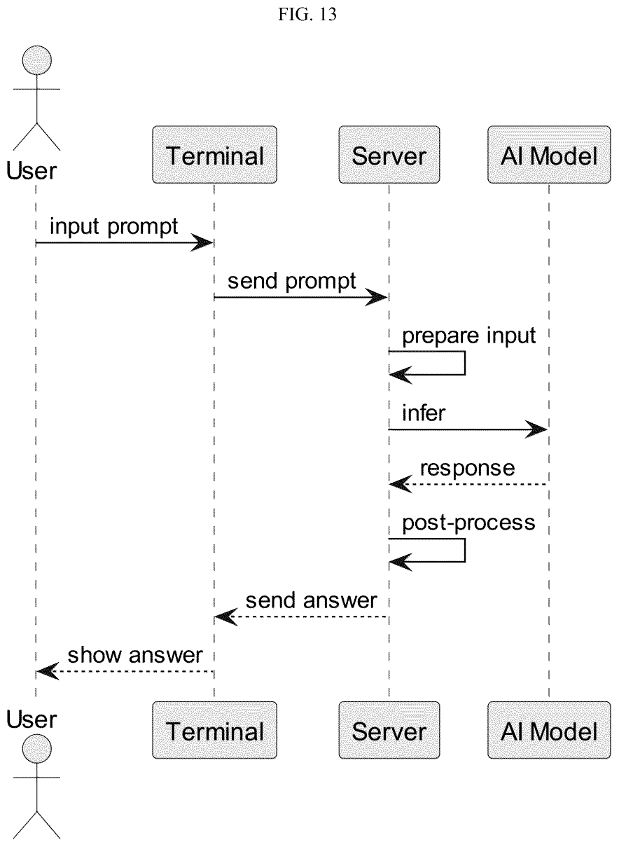

The following describes the processing flow using FIG. 13.

### Step 1

The user operates the terminal to launch a learning application and to open an input screen. The terminal displays a text input field and a send control. The user inputs a prompt sentence in natural language, such as “Explain the main events of the French Revolution in about 300 words.” The terminal receives the keystrokes or touch input via its operating system interface and stores the resulting character sequence in a text buffer in memory.

Input: raw user keystrokes or touch events.

Output: a prompt sentence as a text string stored in a terminal-local buffer.

### Step 2

The terminal validates and structures the prompt sentence. The terminal checks that the prompt sentence is not empty and that its length is within a predefined limit by counting characters or code points. The terminal then creates a structured record containing at least a field for the prompt sentence, a user identifier, a language code, and a timestamp. The terminal assigns each element to a specific field in the record data structure.

Input: the prompt sentence text string and local user/session metadata.

Output: a structured record representing the prompt sentence and associated metadata.

### Step 3

The terminal prepares and transmits a request to the server. The terminal converts the structured record into a transmittable representation, such as a serialized object, and opens a secure communication channel using a network protocol. The terminal sets request headers including content type and authentication information, and writes the serialized data into the body of the request. The terminal then sends the request over the network interface to the server and records a local identifier to correlate the outgoing request with a future response.

Input: the structured record for the prompt sentence.

Output: a network request packet containing the structured information, transmitted to the server.

### Step 4

The server receives and parses the incoming request. The server's network interface captures the request packet and forwards it to an application process. The server reads the packet payload, decodes the serialized representation, and reconstructs the structured record containing the prompt sentence and metadata. The server verifies that required fields are present and that the data types are valid.

Input: the network request packet from the terminal.

Output: an internal structured object on the server representing the prompt sentence and user metadata.

### Step 5

The server normalizes the prompt sentence and augments it with user attribute information. The server retrieves user attribute information from a storage device by using the user identifier as a key, and loads fields such as learning level and preferred language. The server then applies a text normalization procedure to the prompt sentence: the server standardizes character encoding, removes invalid control symbols, and normalizes whitespace. The server stores the normalized text and associated user attributes into an internal data structure dedicated to model input preparation.

Input: the structured object containing the raw prompt sentence, and user attribute information from storage.

Output: a normalized prompt sentence and an enriched data structure containing both normalized text and user attributes.

### Step 6

The server generates model input data for the generative AI model. The server constructs a model input object that includes the normalized prompt sentence and instruction content specifying desired answer properties, such as target difficulty level, response length constraints, and style guidelines. The server also sets generation parameters, including a maximum output token count, a temperature value, and one or more sampling thresholds. The server composes these elements into a format required by the generative AI model, mapping each logical field to a specific position or key in the model input object.

Input: the normalized prompt sentence and enriched user attribute data.

Output: a model input object ready to be passed to the generative AI model.

### Step 7

The server tokenizes the model input data. The server applies a tokenizer associated with the generative AI model to convert the text portions of the model input object into sequences of integer token identifiers. The server performs a lookup in the tokenizer's vocabulary table for each subword or word segment, and appends the corresponding token identifier to a token sequence array. The server also inserts any required special tokens, such as start-of-sequence and separator tokens, at defined positions.

Input: the model input object containing textual content and instructions.

Output: one or more token sequences represented as arrays of integer token identifiers.

### Step 8

The server performs inference with the generative AI model. The server loads the token sequences into the generative AI model's input buffers and executes the forward pass of the transformer-based neural network. The server computes embedding vectors for each token identifier, applies positional encodings, and successively computes self-attention and feed-forward layer outputs using matrix multiplications and activation functions. The server iteratively generates output token probabilities, and applies a decoding algorithm that selects output tokens according to the configured temperature and sampling thresholds. The server continues this process until an end-of-sequence token is generated or the maximum token count is reached.

Input: token sequences derived from the model input data and current model parameters.

Output: a sequence of output token identifiers representing the raw generated response.

### Step 9

The server detokenizes and assembles the response sentence. The server takes the output token identifiers and uses the tokenizer's reverse mapping to convert each token identifier into a character sequence. The server concatenates these character sequences in token order, inserting any necessary spaces or punctuation corrections according to the tokenizer rules. The server then obtains a raw response sentence in natural language and removes auxiliary special tokens that are not intended for display.

Input: the output token identifier sequence.

Output: a raw response sentence text string.

### Step 10

The server post-processes the response sentence with length control. The server measures the length of the raw response sentence by counting characters, words, or tokens, and compares the measurement to the requested or configured length constraints. When the response exceeds an upper threshold, the server truncates the text at a sentence boundary nearest to the threshold by scanning for end-of-sentence punctuation. When the response is shorter than a minimum threshold and additional generation is configured, the server may resume inference to extend the output within allowable limits.

Input: the raw response sentence.

Output: a length-adjusted response sentence.

### Step 11

The server applies formatting and content filtering to the response sentence. The server analyzes the sentence structure by scanning for headings, lists, and key phrases, and inserts line breaks and bullet markers according to a formatting policy. The server evaluates the content using a set of rules or classifiers that check topic relevance and detect disallowed categories. The server removes or masks segments that fail content checks and may insert replacement text such as generic warnings. The server then packages the resulting text as a post-processed response sentence.

Input: the length-adjusted response sentence.

Output: a formatted and content-filtered response sentence.

### Step 12

The server updates interaction history data. The server creates a record that includes the prompt sentence, the post-processed response sentence, timestamps, user identifiers, and any computed indicators such as estimated comprehension or emotional state. The server writes this record to persistent storage, either appending to a log or updating a user-specific history table. The server may also update aggregated statistics, such as the total number of interactions or an average comprehension index, by reading existing values, computing updated values, and writing them back.

Input: the original prompt sentence, the post-processed response sentence, and associated metadata.

Output: an updated interaction history data structure stored in the server's storage device.

### Step 13

The server transmits the post-processed response sentence and relevant metadata to the terminal. The server composes a response message containing the formatted response text, an identifier correlating to the original request, and optionally summary information such as model name, token counts, or flags indicating applied filters. The server encodes this data into a transmittable representation and uses the network interface to send the response message back to the terminal over the established communication channel.

Input: the post-processed response sentence and associated metadata.

Output: a network response packet sent to the terminal.

### Step 14

The terminal receives and decodes the server response. The terminal's communication interface captures the response packet and passes it to the client application. The terminal decodes the packet payload, reconstructs the response message object, and extracts the formatted response sentence and metadata. The terminal uses the correlation identifier to match the response with the original prompt sentence stored locally.

Input: the network response packet from the server.

Output: a local response object containing the formatted response sentence and associated metadata.

### Step 15

The terminal updates the user interface to present the response and learning history. The terminal inserts the new response sentence into a conversation view alongside the corresponding prompt sentence. The terminal arranges the items in chronological order and redraws the display region, applying text layout and styling based on the received formatting markers. The terminal also updates any visible learning history panels by adding a new entry or adjusting summary statistics.

Input: the local response object and locally stored prompt sentence.

Output: an updated visual representation on the display that shows the prompt sentence, the response sentence, and the associated learning context.

### Step 16

The user reviews the displayed response and optionally provides additional input. The user reads the response sentence on the terminal's display, evaluates the clarity or depth of the explanation, and decides whether to ask a follow-up question. When the user desires further information or a different level of explanation, the user enters a new prompt sentence, such as “Explain the same events in simpler words for a middle-school student.” The terminal captures this new input and initiates a new cycle of processing starting from the earlier steps.

Input: the displayed response sentence and associated learning history as perceived by the user.

Output: a new prompt sentence entered by the user, which becomes the input for the next processing cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented dialog systems and learning support systems typically generate responses based only on the most recent user input, with limited or no integration of long-term user interaction history, inferred comprehension level, or detected emotional state. As a result, such systems often provide responses that are either too simple or too complex, and that do not adapt their tone, level of detail, or instructional strategy to the specific state of the individual learner. Existing systems that do invoke a generative AI model generally pass through the raw user query as a prompt, without systematically encoding machine-inferred user state and policy directives into the prompt. This leads to suboptimal use of the generative AI model, unstable response quality, and an inability to progressively personalize responses over multiple dialog turns.

From the standpoint of computer technology, these limitations manifest as inefficient control of a generative AI model by a host system, insufficient data fusion between user interaction logs, emotion recognition outputs, and subject-matter retrieval results, and a lack of structured prompt construction logic in the server-side processing pipeline. The processing resources of the generative AI model are not effectively leveraged, server-side learning history data are not exploited to control the generation, and emotion recognition outputs are not consistently reflected in response generation. Consequently, the overall human-machine interaction quality remains low, and the underlying information processing apparatus does not achieve an improved, state-aware response generation behavior at the system level.

Accordingly, there is a need for a computer-implemented technique that, within a single integrated processing pipeline, (i) acquires and analyzes learner input using natural language processing, (ii) estimates a comprehension level index from past interaction and learning history using a machine learning model, (iii) determines an emotion state index from multimodal learner data, (iv) derives guidance policy information from those indices, and (v) constructs and supplies a structured prompt sentence to a generative AI model. There is a further need for such a technique to iteratively update the comprehension and emotion indices and to modify the prompt construction and guidance policy over successive turns, thereby technically improving the way a server controls a generative AI model to generate responses that are progressively personalized, stable, and appropriate for the user's state.

The specific processing by the specific processing unit 290 of the data processing device 12 in Application Example 2 is realized by the following means.

The present invention provides a server comprising a processor configured to acquire input including at least one of audio data and character data from a learner, to analyze the input by natural language processing to extract subject information and learning requirement information, to estimate a comprehension level index based on at least one of dialog history and learning history of the learner by using a machine learning model, to determine an emotion state index by performing emotion recognition processing on at least one of the audio data, the character data, and image data of the learner, to determine guidance policy information including at least a difficulty level of explanation, an amount of content, and an expression tone based on the subject information, the comprehension level index, and the emotion state index, to acquire information corresponding to the subject information from an information storage device, to construct a prompt sentence described in a natural language and including the guidance policy information as instruction content to be provided to a generative AI model, to input the prompt sentence to the generative AI model so as to cause the generative AI model to generate at least one of learning content and an answer sentence, to format a generation result to generate response data for output, and to transmit the response data for output to a terminal device so that the terminal device presents the response data as at least one of visual display and audio output, and further configured to, in some embodiments, include in the guidance policy information at least one of a stepwise explanation request, an additional example request, and a comprehension-checking question request, to embed the guidance policy information in the prompt sentence, to automatically generate a follow-up message for the learner based on a generation result from the generative AI model, to update the comprehension level index and the emotion state index each time a plurality of dialogs with the learner are performed, and to modify a structure of the prompt sentence and the guidance policy information based on the updated indices so as to generate responses that are progressively personalized as the dialog continues. This enables the server, as an information processing apparatus, to technically improve control over the generative AI model by dynamically constructing state-aware prompt sentences, by fusing user history data and emotion recognition outputs into the generation process, and by iteratively adapting response generation behavior across multiple dialog turns, thereby enhancing computational efficiency, stability, and personalization of system-generated responses.

The term “learner” refers to a human user who interacts with the system for the purpose of acquiring knowledge or skills in at least one subject or domain.

The term “input” refers to information received from the learner by the system, including at least one of audio data, character data, and image data, that represents a query, request, response, or other communicative content.

The term “audio data” refers to digitized sound signals obtained from a sound-capturing device and representing speech uttered by the learner.

The term “character data” refers to text-based information composed of characters, symbols, or codes that is input by the learner through a text input interface or obtained by converting audio data into text.

The term “image data” refers to digital visual information, including still images or video frames, that represent at least part of the learner or the learner's environment and are suitable for analysis by an image processing or emotion recognition component.

The term “natural language processing” refers to a class of computational techniques for analyzing and transforming human language text, including at least one of tokenization, syntactic analysis, semantic analysis, intent detection, and entity extraction.

The term “subject information” refers to data indicating a topic, field, or content area to which the learner's input relates, and that is extracted from the input by natural language processing.

The term “learning requirement information” refers to data indicating the type of explanation, task, or support requested by the learner, including at least one of a request for an explanation, a request for an example, or a request for a summary.

The term “dialog history” refers to stored records of past exchanges between the learner and the system, including at least learner inputs, system outputs, timestamps, and associated analysis results.

The term “learning history” refers to stored records representing the learner's past learning activities handled by the system, including at least previously accessed topics, difficulty levels, performance indicators, and interaction patterns.

The term “comprehension level index” refers to a numerical or categorical value that indicates the estimated degree of understanding of the learner with respect to one or more subjects or tasks, as inferred by a model of the system.

The term “machine learning model” refers to a computational model trained on data to perform at least one of prediction, classification, or regression tasks, and that outputs, in this context, the comprehension level index based on dialog history and learning history.

The term “emotion recognition processing” refers to computational analysis of at least one of audio data, character data, and image data to determine features indicative of an emotional state of the learner.

The term “emotion state index” refers to a numerical or categorical value representing an inferred emotional condition of the learner, including, for example, frustration, confusion, excitement, or neutrality.

The term “guidance policy information” refers to control information used by the system to specify how to present content to the learner, including at least a difficulty level of explanation, an amount of content, and an expression tone, and optionally including structural instructions such as stepwise explanation or inclusion of examples.

The term “difficulty level of explanation” refers to an attribute within the guidance policy information that specifies a relative complexity or depth of technical detail for content to be provided to the learner.

The term “amount of content” refers to an attribute within the guidance policy information that specifies a relative volume or length of information, including at least one of a short summary, a medium-length explanation, and a detailed exposition.

The term “expression tone” refers to an attribute within the guidance policy information that specifies stylistic aspects of language, such as formality, friendliness, reassurance, or encouragement, to be employed in generated content.

The term “information storage device” refers to a hardware and software combination configured to store and retrieve structured or unstructured data, including at least one of databases, file systems, and other memory subsystems.

The term “prompt sentence” refers to a text expressed in a natural language that includes instruction content to be provided to a generative AI model and that conditions or constrains the generation behavior of the generative AI model.

The term “instruction content” refers to information embedded in the prompt sentence that directs the generative AI model to perform a specified generation task, including at least one of providing an explanation, generating examples, or creating comprehension-checking questions.

The term “generative AI model” refers to a trained computational model that generates natural language or other content based on an input prompt sentence, and that uses statistical or neural methods to produce context-dependent output.

The term “learning content” refers to output generated by the generative AI model that is intended to support the learner's understanding, including at least one of explanations, examples, hints, and practice items.

The term “answer sentence” refers to text generated by the generative AI model that directly responds to a learner's query or request.

The term “generation result” refers to the raw or partially processed output produced by the generative AI model in response to a given prompt sentence.

The term “response data for output” refers to formatted data derived from the generation result and optionally from additional information, structured so as to be presentable by a terminal device to the learner.

The term “terminal device” refers to an end-user apparatus configured to communicate with the server and present content to the learner, including at least one of a mobile communication device, a computing device, a wearable device, and a display device.

The term “visual display” refers to presentation of content on a display unit of the terminal device in a human-readable graphical or textual form.

The term “audio output” refers to presentation of content to the learner as sound, including at least synthesized speech generated from text.

The term “stepwise explanation request” refers to a type of instruction in the guidance policy information that directs the generative AI model to structure an explanation as a sequence of explicit steps or stages.

The term “additional example request” refers to a type of instruction in the guidance policy information that directs the generative AI model to include one or more further illustrative examples beyond a primary explanation.

The term “comprehension-checking question request” refers to a type of instruction in the guidance policy information that directs the generative AI model to generate at least one question intended to assess or confirm the learner's understanding.

The term “follow-up message” refers to system-generated content, subsequent to an initial response, that invites continued interaction, provides further explanation, or requests feedback from the learner.

The term “structure of the prompt sentence” refers to an arrangement and composition of elements within the prompt sentence, including ordering, segmentation, and explicit labeling of parts such as user state description, task instruction, and output format constraints.

The term “progressively personalized responses” refers to system-generated responses whose content and presentation are increasingly tailored to the specific learner over time, based on updated comprehension level indices, emotion state indices, and accumulated interaction data.

In one embodiment, a server executes an AI-based instructional dialog program that cooperates with at least one terminal operated by a user who acts as a learner. The server comprises at least one processor, a memory device storing program code and data structures, and an information storage device such as a database system. The terminal comprises at least one input device including a microphone and a text input interface, and at least one output device including a display unit and, in some embodiments, an audio output unit such as a speaker or headset.

The server executes a program implemented, for example, in a general-purpose programming language, such as a scripting language or a compiled language, and makes use of software libraries for natural language processing, machine learning, and neural-network inference. In one specific implementation, the server uses a natural language processing library such as a statistical or neural language toolkit, a deep learning framework such as a tensor-based computation framework, and a database management system such as a document-oriented database. The server communicates with an external generative AI model through an application programming interface provided by a remote computation platform. The generative AI model is, for instance, a large-scale neural-network-based language model that receives a prompt sentence as text and produces a natural-language output.

The terminal acquires input from the user. The terminal receives spoken input through the microphone and character input through a keyboard, touch interface, or similar device. In an embodiment using voice, the terminal uses speech recognition software, such as a cloud-based speech-to-text service, to convert audio waveforms into character data. The terminal stores the recognized text in a local memory buffer along with metadata including at least a timestamp and a confidence score. The terminal then transmits the character data and metadata to the server via a communication network using a communication protocol such as HTTP or a persistent bidirectional protocol such as WebSocket. In another embodiment, the terminal accepts direct text input from the user without speech recognition and transmits the text input to the server in a similar manner. In some configurations, the terminal additionally captures image data of the user's face or environment through a camera and includes a reference to such image data in a message to the server.

The server receives the input from the terminal and stores it in a structured message object in memory. The server uses a natural language processing module to analyze the received character data. The server tokenizes the text, assigns part-of-speech tags, segments sentences, and performs dependency parsing to construct a syntactic structure. The server also executes named-entity recognition to extract subject information such as topic names, mathematical concepts, historical events, or literary works. For example, when the user says “Tell me about the Napoleonic Wars,” the server extracts “Napoleonic Wars” as subject information. When the user says “How do I solve a quadratic equation?”, the server extracts “quadratic equation” and “solve” as subject information and learning requirement information.

The server maintains dialog history and learning history for each learner. The dialog history includes at least past user inputs, system responses, timestamps, and associated analysis results. The learning history further includes features such as topic identifiers, estimated difficulty levels of past questions, correctness indicators for quiz-type interactions, and counts of clarification requests. The server stores these histories in the information storage device using a predefined schema, for example, as documents containing user identifiers, arrays of exchanges, and derived feature vectors.

The server estimates a comprehension level index for the learner. The server forms a feature vector that includes numerical and categorical features derived from the dialog history and learning history, such as: (i) total number of interactions; (ii) distribution of topics by difficulty; (iii) frequency of phrases indicative of misunderstanding (for example, “I don't understand,” “this is too hard”); (iv) accuracy scores on prior quiz questions; and (v) time intervals between question and answer. The server inputs this feature vector into a trained machine learning model. In one embodiment, the machine learning model is a feed-forward neural network having one or more hidden layers, each with non-linear activation functions such as rectified linear units. The model is trained offline with supervised learning using historical labeled data indicating ground-truth comprehension levels such as “beginner,” “intermediate,” and “advanced.” The server uses an error function such as cross-entropy loss for classification or mean squared error for regression, and updates the weights of the neural network according to a gradient-based optimization algorithm such as stochastic gradient descent or an adaptive gradient method. The training process optionally uses regularization techniques and data augmentation on interaction sequences to improve generalization. After training, the server loads the model parameters into memory and executes a forward pass at runtime to output a comprehension level index for the current learner and context.

The server also determines an emotion state index. The server applies emotion recognition processing to at least one of the user's character data, audio data, and image data. For character data, the server uses a text-based sentiment and emotion classifier, which may be implemented as a recurrent neural network, a transformer-based classifier, or a logistic regression model using features such as word embeddings, part-of-speech sequences, and punctuation patterns. For audio data, the server extracts acoustic features such as pitch, energy, spectral coefficients, and speaking rate, and applies a trained classifier to infer emotional categories such as “frustration,” “confusion,” “excitement,” or “neutral.” For image data, the server uses a convolutional neural network to analyze facial landmarks and expressions. The server can also use a cloud-based emotion recognition service. The server fuses the outputs from text, audio, and image classifiers using a rule-based algorithm or a learned fusion network, and represents the final emotion state index as a categorical label or as a vector of scores. The server stores the emotion state index along with the associated dialog entry in the information storage device.

The server computes guidance policy information by combining the subject information, the comprehension level index, and the emotion state index. The server uses a policy module that may be implemented using rule sets, decision trees, or another machine learning model. The server determines at least a difficulty level of explanation, an amount of content, and an expression tone. For example, when the comprehension level index indicates “beginner” and the emotion state index indicates “frustration,” the server selects a low difficulty level, a moderate content amount, and a supportive, reassuring tone. The server further decides whether to request a stepwise explanation, to include additional examples, and to ask comprehension-checking questions. The server encodes such choices into structured control parameters within the guidance policy information.

The server retrieves subject-related information from the information storage device. In one embodiment, the server queries a content database using the extracted subject information as keywords. The server obtains pre-authored definitions, outlines, example problems, and links to external resources. The server may store this content as structured documents containing fields such as “summary,” “detailed_explanation,” and “examples.” The server retrieves appropriate segments based on the guidance policy, for instance, selecting a summary section for users needing only a high-level overview or detailed sections for advanced users. The server then prepares a subset of this content as optional context to be included in or referenced by the prompt sentence.

The server constructs a prompt sentence for the generative AI model. The server generates a natural-language text that encodes (i) a description of the learner's state, including the comprehension level index and emotion state index; (ii) the subject information and learning requirement information; (iii) the guidance policy information specifying difficulty, length, tone, and structural requirements; and (iv) any relevant context from the information storage device. The server organizes this information according to a non-trivial structure designed to control the generative AI model. For example, the server may construct a prompt sentence such as:

“The user is a beginner in algebra and is currently frustrated. The user asked: ‘How do I solve a quadratic equation?’ Explain the method to solve a quadratic equation step by step, using simple language, one or two clear numerical examples, and a reassuring and supportive tone. Avoid heavy formulas, and check understanding at the end.”

In another example, the server constructs a prompt sentence for a history topic as:

“The user is an intermediate-level history learner and seems excited. The user asked: ‘Tell me about the Napoleonic Wars.’ Provide a detailed explanation of the Napoleonic Wars, including causes, major campaigns, key battles, and long-term consequences, suitable for an interested adult learner. Use clear structure and headings.”

In a further example, the server constructs a prompt sentence for procedural guidance as:

“The user is assembling a device and feels frustrated. The user said: ‘I don't know how to attach this part.’ Give calm, concise, step-by-step instructions to attach part A to part B. Use short sentences and reassuring language.”

The server thereby employs a specific prompt-construction algorithm that is not a mere pass-through of the user's input but instead fuses structured, machine-inferred state and guidance policy into a control signal for the generative AI model. This structured prompt sentence improves the stability and appropriateness of model outputs, reduces the need for repeated calls, and enhances computational efficiency because the generative AI model receives more precise instructions tailored to the learner's state.

The server sends the constructed prompt sentence to the generative AI model through an interface. The generative AI model is, for instance, a transformer-based neural network with multiple attention layers, trained on large text corpora by next-token prediction. The model uses an internal tokenization scheme to map the prompt sentence to a sequence of tokens and computes contextual embeddings via stacked self-attention and feed-forward sub-layers. During training, the model minimized a loss function such as cross-entropy between predicted and actual tokens and updated weights using a gradient-based optimizer. At runtime, the model receives generative parameters such as maximum token count and sampling temperature, and outputs a text sequence consistent with the prompt sentence. The server receives this output as a generation result.

The server post-processes the generation result. The server optionally truncates or splits the result according to the amount of content defined in the guidance policy. The server adds headings or bullet points to the output for readability on small displays. The server may append or interleave pre-retrieved content from the information storage device, for instance, inserting a canonical formula or diagram reference after the generative explanation. The server may also construct a follow-up message, either by requesting the generative AI model to generate an additional question or by using a rule-based template, so that the learner can confirm understanding or request another example. The server formats the final response as response data for output, including the main explanation, any additional examples, and any comprehension-checking questions.

The terminal receives the response data from the server. The terminal parses the response and displays the text on a graphical user interface, such as a chat window or a learning interface. When the terminal is a wearable display device such as smart glasses, the terminal overlays short text instructions within the user's field of view. The terminal may also convert the text into audio output using a text-to-speech engine, thereby enabling hands-free usage in physical tasks. For example, in an assembly scenario, the terminal displays “First, attach part A to part B” and optionally reads the sentence aloud to guide the user's hands-on operation.

The server updates the comprehension level index and emotion state index after each exchange. The server uses the new interaction data, including the user's follow-up messages and non-verbal cues, to compute updated feature vectors and execute the machine learning models again. The server thereby refines its estimate of the learner's state and modifies the structure of subsequent prompt sentences and guidance policy information. Through this iterative updating and prompt restructuring, the server generates responses that become progressively more personalized as the dialog continues. This adaptation is not a simple automation of human tutoring behavior but a specific improvement to computer technology: the server designs and modifies internal control signals (prompt sentences and guidance policies) that directly affect generative model behavior, which in turn reduces the number of ineffective responses and reduces overall network and computation load.

The described system achieves several technical effects. The explicit combination of dialog history, learning history, and emotion recognition into a comprehension level index and emotion state index allows the server to select guidance policies that reduce unnecessary calls to the generative AI model and minimize trial-and-error prompts. By providing constrained and state-aware prompt sentences, the server reduces divergence and hallucination behavior of the generative AI model, thereby improving the accuracy and reliability of responses. By structuring the prompt sentence with explicit sections for user state, task specification, and output formatting, the server enables the generative AI model to converge more quickly to relevant outputs, improving response latency and computational efficiency. By maintaining data structures with indexed histories and feature vectors, the server can perform efficient retrieval and model inference, improving scalability when thousands of learners use the system concurrently.

In addition, the system facilitates technical improvements in data management and communication. The server caches comprehension level indices and emotion state indices, reducing repeated computation on stable states and thus lowering processor load. The server in some embodiments transmits only summarized state indicators and compact prompt sentences to the generative AI model endpoint, reducing communication bandwidth compared to transmitting entire histories or raw logs. The use of well-defined feature vectors and model architectures ensures that processing can be distributed or parallelized across compute nodes, further reducing response time.

In one alternative embodiment, the server uses a different neural-network architecture for the comprehension level index, such as a recurrent neural network that processes sequences of dialog turns, or a transformer-based encoder that attends over past utterances. In another embodiment, the server employs a rule-based emotion recognizer for domain-specific phrases, supplementing or replacing a neural classifier. In a further embodiment, the server runs a locally hosted generative AI model instead of a remote one, with optimized weight matrices and reduced precision arithmetic to improve inference speed on specialized hardware accelerators. In yet another embodiment, the server integrates additional sensing data, such as eye-tracking information from the terminal, to refine the emotion state index and adjust the guidance policy accordingly.

The user benefits from these technical improvements because the server delivers responses that are accurately tailored to the user's understanding and emotional state and that appear with reduced delay thanks to optimized computational and communication processes. However, the core contribution resides in the internal operation of the server and its cooperation with the generative AI model and the terminal: the server uses specific data structures, machine learning models, and prompt-construction procedures to control generative computation in a way that improves the functioning of the computer system itself, rather than merely automating a preexisting manual teaching process.

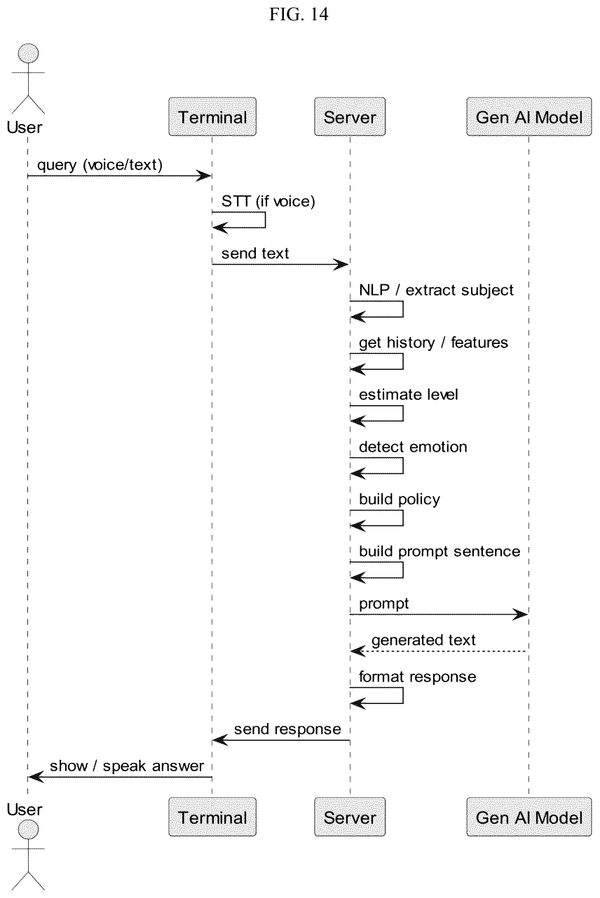

The following describes the processing flow using FIG. 14.

### Step 1

User provides an initial query.

User speaks into a microphone of the terminal or types text into a user interface on the terminal. The input is, for example, an utterance such as “How do I solve a quadratic equation?” or “Tell me about the Napoleonic Wars.”

Input: human speech waveform or typed character sequence.

Output: raw audio signal or raw text string captured by the terminal.

### Step 2

Terminal converts audio to text (if voice is used).

Terminal sends the captured audio signal to a speech-to-text component, such as a cloud-based speech recognition service, along with language settings and session identifiers. The speech-to-text component processes the waveform using acoustic and language models and returns a transcription. Terminal stores the returned text and metadata such as confidence and timestamp.

Input: audio waveform from the microphone.

Output: character data representing the recognized text of the user's utterance.

### Step 3

Terminal transmits user input to the server.

Terminal packages the character data (from Step 1 or Step 2) and, optionally, references to audio and image data into a message structure that includes a user identifier, device type, and timestamp. Terminal sends this message to the server over a network using a communication protocol such as HTTP or WebSocket.

Input: character data, optional audio/image references, and session metadata.

Output: structured request message delivered to the server.

### Step 4

Server receives and stores the interaction.

Server accepts the incoming request, parses the message, and extracts fields such as user identifier, character data, and timestamp. Server allocates an internal data object representing the current interaction and writes the raw input and metadata into storage, such as a database entry linked to the user's dialog history.

Input: structured request message containing user's character data and metadata.

Output: internal interaction object stored in memory and persisted in dialog history.

### Step 5

Server performs natural language processing to extract subject and intent.

Server applies a natural language processing pipeline to the character data. Server tokenizes the text, performs part-of-speech tagging, and runs syntactic parsing to identify grammatical relations. Server executes named-entity recognition and intent classification to derive subject information (for example, “quadratic equation,” “Napoleonic Wars”) and learning requirement information (for example, explanation request, example request, summary request).

Input: user's character data from the interaction object.

Output: subject information and learning requirement information, plus linguistic annotations.

### Step 6

Server retrieves dialog and learning history for the learner.

Server queries the information storage device using the user identifier to obtain past dialog entries and learning records. Server compiles features such as previously asked topics, difficulty levels, correctness scores, number of clarifications, and time sequences. Server aggregates these into a structured feature vector representing the learner's historical behavior.

Input: user identifier and database records of past interactions.

Output: feature vector encoding dialog history and learning history.

### Step 7

Server estimates the learner's comprehension level index.

Server feeds the feature vector into a trained machine learning model, such as a feed-forward neural network or another classifier/regressor. Server performs a forward pass through the model, computing weighted sums and non-linear activations over the network layers. Server obtains a predicted comprehension level index, such as a category (“beginner,” “intermediate,” “advanced”) or a numerical score.

Input: feature vector derived from dialog history and learning history.

Output: comprehension level index representing estimated understanding of the learner.

### Step 8

Server determines the learner's emotion state index.

Server processes at least one of the character data, audio data, and image data using emotion recognition algorithms. For text, server extracts features such as word embeddings, sentiment indicators, and punctuation patterns and evaluates them with a text emotion classifier. For audio, server computes acoustic features such as pitch and energy and applies an audio-based emotion model. For image, server analyzes facial expressions via a convolutional network. Server fuses these signals to infer an emotion state index (for example, frustration, confusion, excitement, neutrality) with associated confidence.

Input: character data, optional audio features, optional image features.

Output: emotion state index representing inferred emotional condition of the learner.

### Step 9

Server computes guidance policy information.

Server uses the subject information, learning requirement information, comprehension level index, and emotion state index as inputs to a policy module implemented with rules or a decision model. Server calculates an appropriate difficulty level of explanation (for example, basic, intermediate, advanced), an amount of content (for example, brief, normal, extended), and an expression tone (for example, neutral, encouraging, reassuring). Server also decides whether to request stepwise explanation, additional examples, or comprehension-checking questions and encodes these as flags in the guidance policy information.

Input: subject information, learning requirement information, comprehension level index, emotion state index.

Output: guidance policy information including difficulty, content amount, tone, and structural requests.

### Step 10

Server retrieves subject-related content from storage.

Server constructs a search query based on the subject information and optionally the difficulty level. Server sends the query to the information storage device, which may be a database or content repository, and retrieves relevant entries such as definitions, summaries, detailed explanations, and example problems. Server filters and ranks the retrieved entries according to the guidance policy information and selects those portions that can serve as background or reference content.

Input: subject information and guidance policy information.

Output: selected content segments related to the subject, structured for possible inclusion in the prompt sentence.

### Step 11

Server constructs a prompt sentence for the generative AI model.

Server assembles a natural-language text that includes: (i) a description of the learner's comprehension level index and emotion state index; (ii) the subject information and the learner's original question; (iii) the guidance policy information specifying difficulty, amount, tone, and structure; and (iv) optional background content. Server concatenates these elements in a predefined order and with explicit instructions to control the generative AI model. For example, server constructs a prompt sentence such as:

“The user is a beginner in algebra and is currently frustrated. The user asked: ‘How do I solve a quadratic equation?’ Explain the method to solve a quadratic equation step by step, using simple language, one or two clear numerical examples, and a reassuring and supportive tone. Avoid heavy formulas, and check understanding at the end.”

Input: comprehension level index, emotion state index, subject information, learning requirement information, guidance policy information, and selected content segments.

Output: prompt sentence expressed as a single natural-language text string.

### Step 12

Server calls the generative AI model with the prompt sentence.

Server sends the prompt sentence to the generative AI model via an interface. The generative AI model tokenizes the prompt sentence and performs internal neural-network computation, including self-attention and feed-forward transformations, to predict subsequent tokens. Server specifies generation parameters such as maximum length and sampling temperature. The generative AI model returns generated text constituting at least one of learning content and an answer sentence.

Input: prompt sentence and generative parameters.

Output: generation result text produced by the generative AI model.

### Step 13

Server post-processes the generation result and forms response data.

Server analyzes the generation result to ensure it matches the guidance policy, such as checking length and structure. Server truncates or reorganizes the text into sections, bullet points, or numbered steps according to the requested structure. Server may insert headings or link selected database content after specific portions. Server may also generate or append a follow-up question, either by a template or an additional brief call to the generative AI model, to verify comprehension. Server then packages the finalized text and any associated metadata into response data for output.

Input: generation result text and guidance policy information, plus optional database content.

Output: formatted response data ready for presentation on the terminal.

### Step 14

Server transmits the response data to the terminal.

Server encapsulates the response data in a response message that includes display instructions (for example, whether to show as paragraphs or steps) and flags for optional text-to-speech. Server sends this message to the terminal through the communication network.

Input: response data for output.

Output: response message delivered to the terminal.

### Step 15:

Terminal presents the response to the user.

Terminal parses the response message and renders the explanation, examples, and questions on the display. Terminal formats text with headings and bullet points as specified, and, if a text-to-speech flag is set, passes the text to a speech synthesis engine and plays the resulting audio through an output device. In a wearable configuration, terminal overlays short instructions in the user's field of view.

Input: response message received from the server.

Output: visual display and/or audio output presented to the user.

### Step 16

User reviews the response and provides follow-up input.

User reads or listens to the output and assesses understanding. User may then provide additional input, such as “I still don't understand the second step,” “Show me another example,” or “Now explain the discriminant.” User's new utterance or typed message becomes a new input that restarts the processing loop at the terminal.

Input: explanation and optional follow-up prompts displayed or spoken by the terminal.

Output: new user speech or text input that will be captured again by the terminal.

### Step 17

Server updates user models and adapts future behavior.

Server, upon receiving subsequent interactions (through repetition of Steps 1-15), recalculates the feature vector, runs the comprehension-level and emotion-state models again, and updates stored indices in the database. Server adjusts future guidance policy information and modifies the structure and wording of later prompt sentences so that subsequent calls to the generative AI model are better aligned with the evolving learner profile.

Input: new interaction data, updated dialog history, and recent emotion recognition outputs.

Output: updated comprehension level index, updated emotion state index, and new guidance policy information influencing future prompt sentences and responses.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

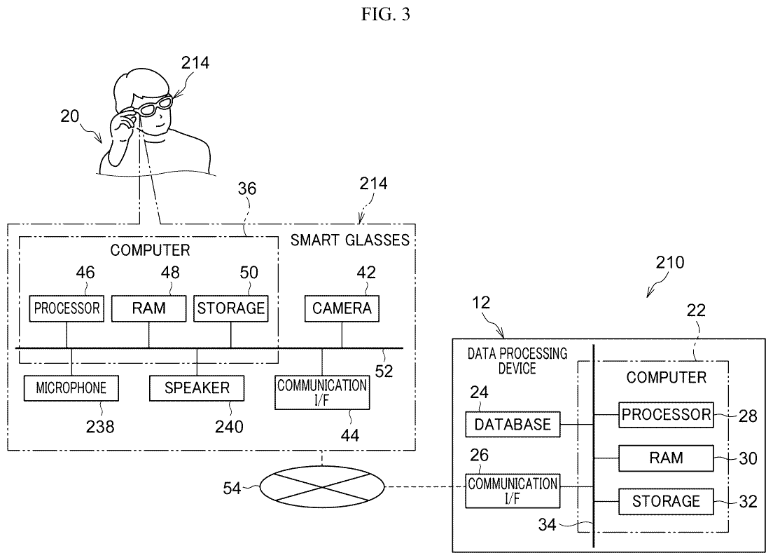

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

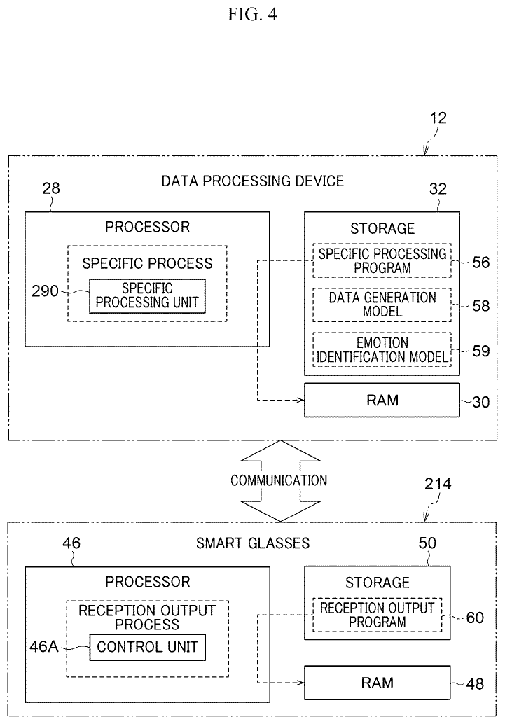

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

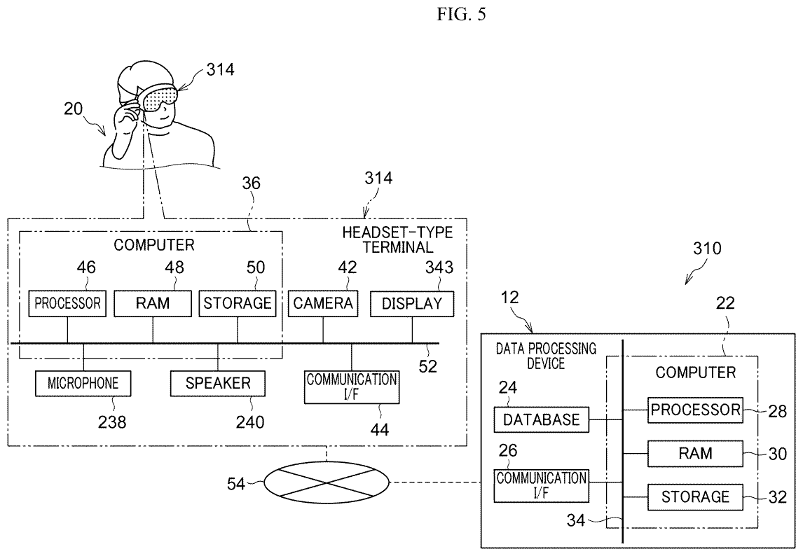

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

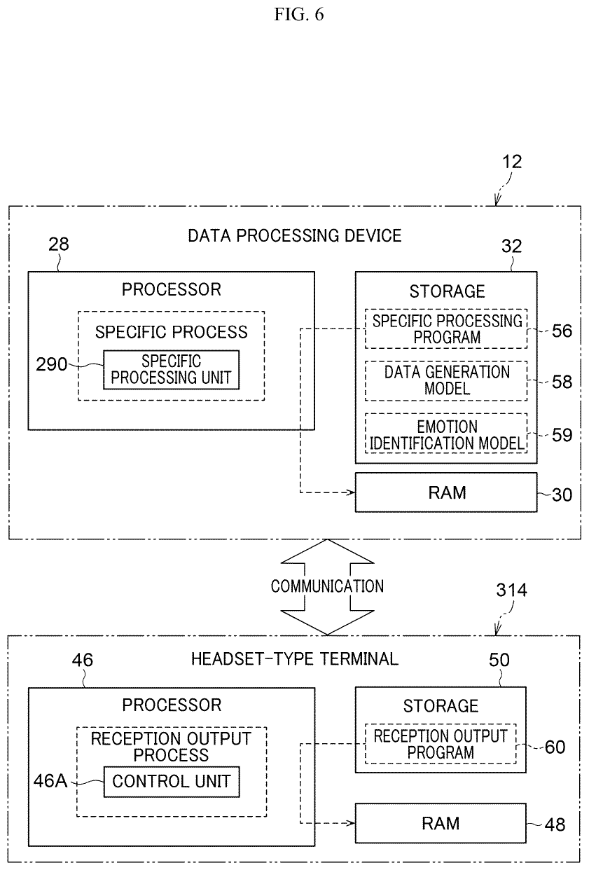

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

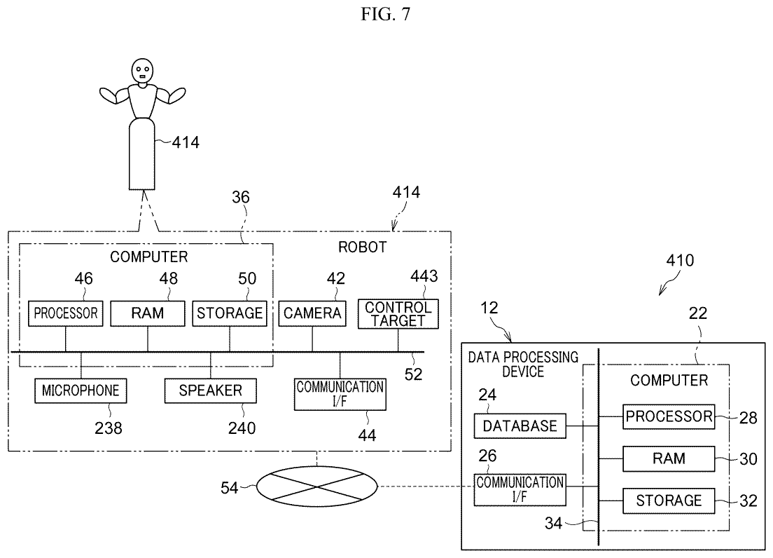

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

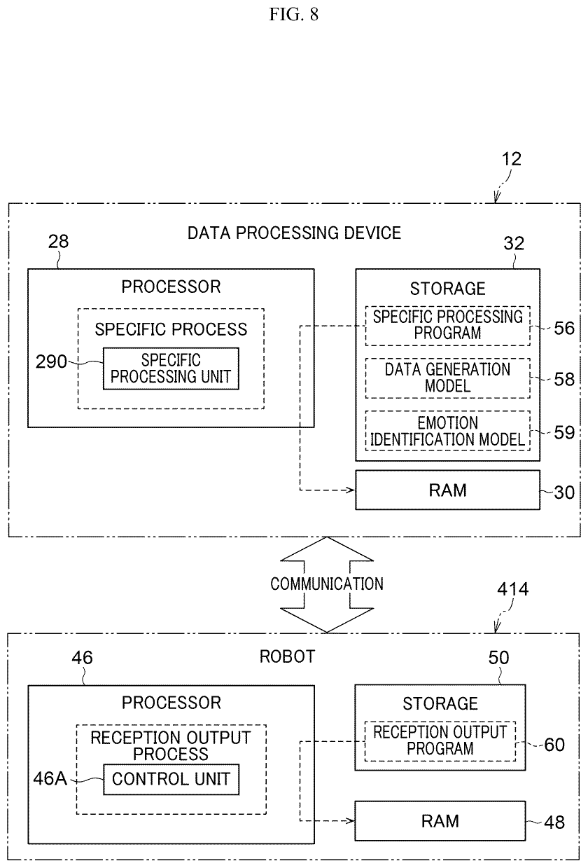

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

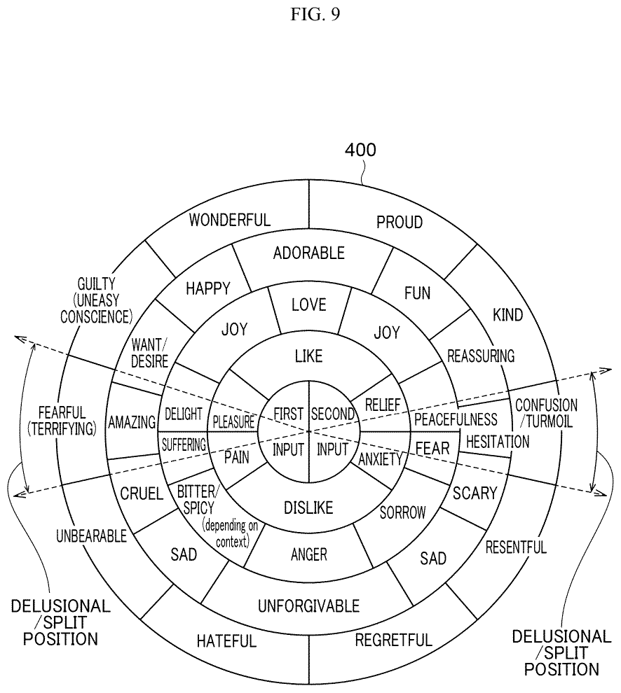

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

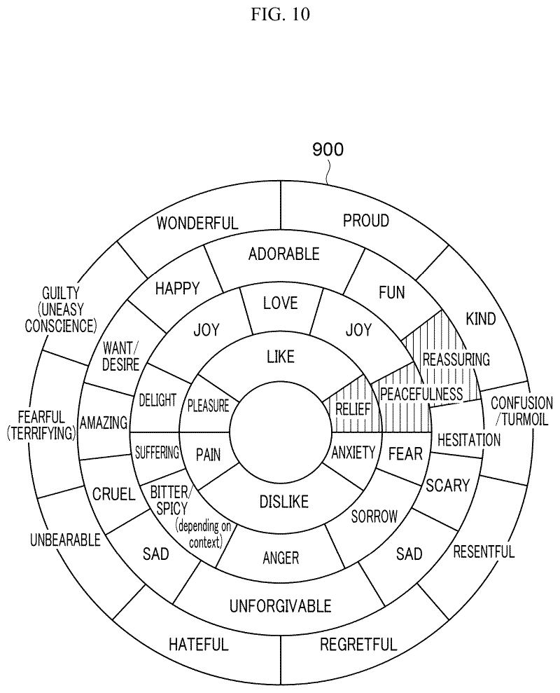

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

Example 1

### Supplementary 1

A system comprising a processor,
wherein the processor is configured to
receive, via a terminal, inquiry input from a learner and acquire the inquiry input as character information,
perform natural language processing on the character information to execute word segmentation, syntactic analysis, semantic analysis, and intent estimation, and extract subject information and learning-purpose information related to the inquiry input,
acquire, from a storage device, learner attribute information and past interaction history information associated with the learner, and determine a learning level, a preferred explanation style, and an area of interest of the learner,
acquire, from a knowledge information storage area, subject-related information based on the subject information and the learning level of the learner, and construct a prompt sentence for input to a generative AI model, the prompt sentence including the subject-related information, the learning-purpose information, and the learning level of the learner,
generate generation request data including the prompt sentence and generation condition information, transmit the generation request data to the generative AI model, and acquire a response character string generated by the generative AI model,
perform inappropriate-content detection and expression-format conversion on the response character string, and format the response character string so as to conform to the learning level and an emotional state of the learner,
transmit the formatted response character string to the terminal and cause the formatted response character string to be presented in a dialog-type display region, and store the inquiry input, the prompt sentence, and the response character string as interaction history, and use the interaction history for configuration of a subsequent prompt sentence and individualized optimization of subsequent response content.

### Supplementary 2

The system according to supplementary 1,
wherein the processor is configured to
accumulate a plurality of past inquiry inputs and response character strings from the learner as interaction history, calculate, based on the interaction history, a comprehension index and an achievement index for each learner, and dynamically adjust, in accordance with the comprehension index and the achievement index, a level of detail of explanation, a degree of use of technical terms, and an amount of output in the prompt sentence.

### Supplementary 3

The system according to supplementary 1,
wherein the processor is configured to
perform emotion estimation processing on audio information and character information acquired from the learner, add, to the prompt sentence, an encouragement expression, a difficulty-change instruction, or an explanation-style-change instruction based on a result of the emotion estimation processing, and control the prompt sentence such that response generation by the generative AI model conforms to the emotional state of the learner.

Application Example 1

### Supplementary 1

A system comprising a processor,
wherein the processor is configured to
receive a learning request expressed in natural language from an information terminal operated by a learner, and convert the learning request into structured information, and acquire learner information including a learner attribute, a learning history, and a target instructional field from an information storage device based on the structured information and learner identification information, and perform intent classification and difficulty estimation for the learning request based on the learner information, and
generate, based on the intent classification and the difficulty estimation, a prompt sentence for input to a generative AI model by integrating, as a text sequence, explanation instruction information including an educational support role, the learner attribute, an explanation level, example conditions, and the learning request, and
encode the prompt sentence into a sequence of divided units, input the encoded sequence to the generative AI model operating on a numerical computation device, and cause the generative AI model to generate an answer candidate text, and
perform, on the answer candidate text, vocabulary level conversion, description format adjustment, and, when necessary, language conversion in accordance with the learner attribute, and output the processed answer candidate text as learning response information to be transmitted to the information terminal, and
store the learning request, the prompt sentence, and the learning response information as a dialogue history in the information storage device, and manage the dialogue history as an individual learning context usable for generation of a subsequent prompt sentence and a subsequent answer.

### Supplementary 2

The system according to supplementary 1,
wherein the processor is configured to
calculate evaluation indices including reference frequency of output content, types of follow-up questions, and learning completion indicators for a plurality of learning requests and learning response information stored as the dialogue history, generate a comprehension index for each learner based on the evaluation indices, and reflect the comprehension index in the prompt sentence so as to automatically adjust the explanation level and an amount of information.

### Supplementary 3

The system according to supplementary 1,
wherein the processor is configured to
execute an emotion estimation process by performing acoustic feature extraction processing and context analysis processing on voice data and text data obtained from the learner, classify an emotional state of the learner, and, in accordance with the emotional state, include, in the prompt sentence, at least one of an encouragement expression, a pace adjustment instruction, and an additional example instruction so as to dynamically change content and expression style of an answer generated by the generative AI model.

### Example 2

### Supplementary 1

A system comprising a processor,
wherein the processor is configured to
receive, from a user terminal, a prompt sentence expressed in natural language, convert the prompt sentence into structured information, and transmit the structured information to an information processing apparatus via a communication network,
analyze, in the information processing apparatus, the received prompt sentence and user attribute information, generate model input data for a generative AI model based on the prompt sentence and the user attribute information, and provide the model input data to the generative AI model so as to cause the generative AI model to generate a response sentence in natural language, perform post-processing on the response sentence output from the generative AI model, the post-processing including at least one of length control, formatting, and content filtering, and transmit a post-processed response sentence to the user terminal, and
control, in the user terminal, a user interface to present the received response sentence on a display device in association with a learning history and to enable a user to continuously input prompt sentences and conduct interactive learning.

### Supplementary 2

The system according to supplementary 1,
wherein the processor is configured to
analyze past interaction data including prompt sentences and response sentences accumulated for each user, calculate a comprehension index based on the past interaction data, and dynamically change at least one of an instruction content included in the model input data and a generation parameter of the generative AI model in accordance with the calculated comprehension index.

### Supplementary 3

The system according to supplementary 1,
wherein the processor is configured to
analyze voice data or text data acquired from the user, estimate an emotional state based on the analyzed data, and change at least one of a condition of the model input data for the generative AI model and a formatting policy in the post-processing in accordance with the estimated emotional state.

Application Example 2

### Supplementary 1

A system comprising a processor,
wherein the processor is configured to
acquire input including at least one of audio data and character data from a learner, and analyze the input by natural language processing to extract subject information and learning requirement information,
estimate a comprehension level index based on at least one of past dialog history and learning history of the learner by using a machine learning model,
determine an emotion state index by performing emotion recognition processing on at least one of the audio data, the character data, and image data of the learner, determine guidance policy information including at least a difficulty level of explanation, an amount of content, and an expression tone, based on the subject information, the comprehension level index, and the emotion state index,
acquire information corresponding to the subject information from an information storage device, and construct a prompt sentence described in a natural language and including the guidance policy information as instruction content to be provided to a generative AI model, input the prompt sentence to the generative AI model so as to cause the generative AI model to generate at least one of learning content and an answer sentence, and format a generation result to generate response data for output, and
transmit the response data for output to a terminal device so that the terminal device presents the response data as at least one of visual display and audio output.

### Supplementary 2

The system according to supplementary 1,
wherein the processor is configured to
include, in the guidance policy information, at least one of a stepwise explanation request, an additional example request, and a comprehension-checking question request, embed the guidance policy information in the prompt sentence, and automatically generate a follow-up message for the learner based on a generation result from the generative AI model.

### Supplementary 3

The system according to supplementary 1,
wherein the processor is configured to
update the comprehension level index and the emotion state index each time a plurality of dialogs with the learner are performed, and modify a structure of the prompt sentence and the guidance policy information based on the updated indices so as to generate responses that are progressively personalized as the dialog continues.

What is claimed is:

1. A system comprising:
circuitry configured to:
acquire, from a terminal device coupled to a packet-switched network via a communication interface, input data comprising at least one of audio data and character data;
apply a natural language processing pipeline to the character data to extract topic identification data and request classification data;
compute a proficiency index associated with a source of the input data by applying a trained machine learning model to feature vectors derived from interaction history records stored in a data storage device coupled to the packet-switched network;
determine an affective state index by performing recognition processing on at least one of the audio data, the character data, and image data received from the terminal device;
generate guidance parameter data specifying at least a complexity level, a content volume, and an output style based on the topic identification data, the proficiency index, and the affective state index;
retrieve, from the data storage device, reference data corresponding to the topic identification data;
construct a prompt sequence for a generative neural network model by combining, in a structured template format, the guidance parameter data as instruction content, the reference data, and the request classification data;
transmit the prompt sequence to the generative neural network model via the communication interface, and receive, from the generative neural network model, a natural-language output;
apply post-processing to the natural-language output, the post-processing comprising at least one of content filtering by a classification model, vocabulary complexity adjustment based on the proficiency index, and structural format conversion; and
store the input data, the prompt sequence, and the post-processed natural-language output as an interaction history record in the data storage device, and update the proficiency index based on the stored interaction history record for use in constructing a subsequent prompt sequence.

2. The system according to claim 1, wherein the circuitry is configured to apply the natural language processing pipeline by performing tokenization on the character data to generate a token sequence, assigning part-of-speech tags to tokens in the token sequence, performing dependency parsing to generate a syntactic structure, and computing a semantic embedding of the character data using a transformer encoder.

3. The system according to claim 2, wherein the circuitry is configured to apply an intent classification sub-model to the semantic embedding and features derived from the syntactic structure to determine the request classification data, the request classification data comprising an intent label selected from a plurality of predetermined intent categories.

4. The system according to claim 3, wherein the circuitry is configured to map the intent label and extracted key phrases from the syntactic structure to the topic identification data using a stored mapping table in the data storage device.

5. The system according to claim 4, wherein the circuitry is configured to select, from the reference data, content segments having a complexity matching the complexity level specified in the guidance parameter data, such that a depth of retrieved content is adapted based on the proficiency index.

6. The system according to claim 1, wherein the circuitry is configured to compute the proficiency index by extracting, from the interaction history records, numerical features comprising at least a count of prior interactions, a distribution of topic difficulty values, a frequency of clarification-type requests, and temporal intervals between successive interactions, combining the numerical features into a feature vector, and applying a feed-forward neural network with at least one hidden layer and a non-linear activation function to the feature vector to output the proficiency index.

7. The system according to claim 6, wherein the circuitry is configured to compute, from the interaction history records, an achievement index representing progress toward completion of a series of interactions, and to incorporate the achievement index into the guidance parameter data to adjust the content volume of the prompt sequence.

8. The system according to claim 7, wherein the circuitry is configured to update parameters of the feed-forward neural network based on accumulated interaction history records using a gradient-based optimization algorithm with a cross-entropy loss function.

9. The system according to claim 8, wherein the circuitry is configured to bypass full generative neural network model inference for a subsequent interaction when the proficiency index exceeds a predetermined threshold by retrieving a cached prior natural-language output matching the topic identification data and applying only the vocabulary complexity adjustment.

10. The system according to claim 1, wherein the circuitry is configured to determine the affective state index by extracting acoustic features comprising pitch, energy, and spectral coefficients from the audio data, extracting textual sentiment features from the character data, and applying a multi-modal fusion model that combines the acoustic features and the textual sentiment features to output a categorical affective state label.

11. The system according to claim 10, wherein the circuitry is configured to determine the affective state index further based on image data received from the terminal device by applying a convolutional neural network to facial landmark data extracted from the image data and fusing an output of the convolutional neural network with the acoustic features and the textual sentiment features.

12. The system according to claim 11, wherein the circuitry is configured to, when the affective state index indicates a negative state, modify the prompt sequence by appending at least one of an encouragement expression, a complexity reduction instruction, and a pacing adjustment instruction to the instruction content of the prompt sequence.

13. The system according to claim 12, wherein the circuitry is configured to update the affective state index after each interaction by performing recognition processing on new input data from the terminal device, and to progressively modify the instruction content of successive prompt sequences based on a trajectory of affective state index values across a plurality of interactions.

14. The system according to claim 1, wherein the circuitry is configured to construct the prompt sequence by generating a role-specification segment defining a functional role for the generative neural network model, a context segment encoding the proficiency index and the affective state index as textual descriptors, a content segment incorporating the reference data and the request classification data, and a query segment comprising a normalized representation of the input data, and concatenating the segments in a predetermined order.

15. The system according to claim 1, wherein the circuitry is configured to apply the content filtering by encoding the natural-language output as an embedding vector, applying a binary classifier to the embedding vector to determine whether the natural-language output satisfies predetermined content criteria, and upon a negative determination, transmitting a modified prompt sequence with additional constraint parameters to the generative neural network model for regeneration.

16. The system according to claim 1, wherein the circuitry is configured to perform the vocabulary complexity adjustment by comparing tokens in the natural-language output against a vocabulary mapping table that associates complex tokens with simpler equivalent tokens, and replacing tokens that exceed a complexity threshold determined by the proficiency index.

17. The system according to claim 1, wherein the input data comprises an inquiry related to an educational subject, the topic identification data identifies the educational subject, and the reference data comprises instructional content retrieved from a knowledge repository associated with the educational subject.

18. A system comprising:
circuitry configured to:
acquire, from a terminal device coupled to a packet-switched network via a communication interface, character data representing a natural-language request and at least one of audio data and image data associated with a source of the character data;
perform tokenization on the character data using a stored vocabulary to generate a token sequence, perform dependency parsing on the token sequence to generate a syntactic structure, and compute a semantic embedding of the token sequence using a neural network encoder;
apply an intent classifier to the semantic embedding and features of the syntactic structure to generate request classification data comprising an intent label and extracted topic key phrases;
retrieve, from a data storage device coupled to the packet-switched network, a user profile record associated with the source of the character data, the user profile record comprising attribute data, interaction history records, and a stored proficiency index;
update the proficiency index by extracting, from the interaction history records, numerical features comprising interaction counts, topic difficulty distributions, clarification request frequencies, and temporal intervals, combining the numerical features into a feature vector, and applying a trained classification model to the feature vector;
determine an affective state index by extracting acoustic features from the audio data and textual sentiment features from the character data, and applying a multi-modal classifier that fuses the acoustic features and the textual sentiment features to output a categorical affective state label;
determine guidance parameter data specifying a complexity level, a content volume, an output style, and at least one of a stepwise explanation directive, an additional example directive, and a verification question directive, based on the intent label, the updated proficiency index, and the affective state index;
retrieve, from a knowledge data region of the data storage device, reference content segments corresponding to the extracted topic key phrases and filtered by the complexity level;
construct a prompt sequence for a generative neural network model by concatenating, in a structured template format, a role-specification segment, a context segment encoding the updated proficiency index and the affective state index, the guidance parameter data as instruction content, the reference content segments, and a query segment comprising the character data;
encode the prompt sequence into a token index sequence using a subword tokenizer, transmit the token index sequence and generation condition parameters comprising a maximum output token count and a sampling temperature to the generative neural network model via the communication interface, and receive a generated token index sequence;
decode the generated token index sequence into a natural-language output, apply content filtering using a binary classifier, perform vocabulary complexity adjustment by comparing tokens against a mapping table indexed by the updated proficiency index, and apply structural format conversion;
transmit the post-processed natural-language output to the terminal device for presentation via at least one of visual display and audio output; and
store the character data, the prompt sequence, and the post-processed natural-language output as a new interaction history record in the data storage device, and update the user profile record including the proficiency index and the affective state index for use in constructing subsequent prompt sequences with progressively adapted guidance parameter data.

19. The system according to claim 18, wherein the circuitry is configured to generate a follow-up message by constructing an additional prompt sequence that includes a verification question directive derived from the guidance parameter data, transmitting the additional prompt sequence to the generative neural network model, and appending a generated verification question to the post-processed natural-language output before transmitting to the terminal device.

20. A method performed by circuitry, the method comprising:
acquiring, from a terminal device coupled to a packet-switched network via a communication interface, input data comprising at least one of audio data and character data;
applying a natural language processing pipeline to the character data to extract topic identification data and request classification data;
computing a proficiency index associated with a source of the input data by applying a trained machine learning model to feature vectors derived from interaction history records stored in a data storage device coupled to the packet-switched network;
determining an affective state index by performing recognition processing on at least one of the audio data, the character data, and image data received from the terminal device;
generating guidance parameter data specifying at least a complexity level, a content volume, and an output style based on the topic identification data, the proficiency index, and the affective state index;
retrieving, from the data storage device, reference data corresponding to the topic identification data;
constructing a prompt sequence for a generative neural network model by combining, in a structured template format, the guidance parameter data as instruction content, the reference data, and the request classification data;
transmitting the prompt sequence to the generative neural network model via the communication interface, and receiving, from the generative neural network model, a natural-language output;
applying post-processing to the natural-language output, the post-processing comprising at least one of content filtering by a classification model, vocabulary complexity adjustment based on the proficiency index, and structural format conversion; and
storing the input data, the prompt sequence, and the post-processed natural-language output as an interaction history record in the data storage device, and updating the proficiency index based on the stored interaction history record for use in constructing a subsequent prompt sequence.
